(19) United States
(12) Patent Application Publication
(10) Pub. No.: US 2026/0122492 A1
(43) Pub. Date: Apr. 30, 2026

(54) CENTRALIZED MANAGEMENT CLOUD CONNECTING MULTIPLE ENTERPRISE NETWORKS

(71) Applicant: QUALCOMM Incorporated, San Diego, CA (US)

(72) Inventors: Noam IVRI, Modiin (IL); Pavel LIVSHITS, Modiin (IL); David RONEN, Kfar Saba (IL)

(21) Appl. No.: 18/933,843

(22) Filed: Oct. 31, 2024

(51) Int. Cl. H04W 12/069; H04W 4/029; H04W 64/00

(52) U.S. Cl. CPC H04W 12/069; H04W 4/029; H04W 64/006

(57) ABSTRACT

This disclosure provides systems, methods and apparatus, including computer programs encoded on computer storage media, for centralized management cloud connecting multiple enterprise networks. A network agent may be deployed within a private cellular network and act as an interface between the node(s) of the private cellular network and a cloud network controller. The network agent may obtain a local-based request to initiate a cloud-based procedure associated with network parameter(s), the network parameter(s) being associated with cloud network credential(s) that correspond to the private cellular network. The network agent may output a cloud-based request to the cloud network controller to initiate the cloud-based procedure. The cloud-based request may indicate at least a portion of the network parameter(s) and omit at least a portion of local credential(s) of the private cellular network. The cloud-based request may hide the cloud network credentials of the private cellular network from the cloud network controller.

### TECHNICAL FIELD

This disclosure relates to wireless communications, including centralized management cloud connecting multiple enterprise networks.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-s-OFDM). A wireless multiple-access communications system may include one or more base stations (BSs) or one or more network access nodes, each simultaneously supporting communication for multiple communication devices, which may be otherwise known as user equipment (UE).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications at a network agent. The method may include obtaining a local-based request to initiate a cloud-based procedure associated with one or more network parameters, where the one or more network parameters are associated with one or more cloud network credentials that correspond to a private cellular network and outputting a cloud-based request to initiate the cloud-based procedure in accordance with the local-based request, where the cloud-based request indicates at least a portion of the one or more network parameters and omits at least a portion of one or more local credentials of the private cellular network.

Another innovative aspect of the subject matter described in this disclosure can be implemented at a network agent for wireless communications. The network agent may include a processing system that includes processor circuitry that stores code, the processing system configured to cause the network agent to obtain a local-based request to initiate a cloud-based procedure associated with one or more network parameters, where the one or more network parameters are associated with one or more cloud network credentials that correspond to a private cellular network and output a cloud-based request to initiate the cloud-based procedure in accordance with the local-based request, where the cloud-based request indicates at least a portion of the one or more network parameters and omits at least a portion of one or more local credentials of the private cellular network.

In some examples of the method, network agents, and non-transitory computer-readable medium described herein, the network agent obtains the local-based request from a network device of the private cellular network associated with the network agent.

In some examples of the method, network agents, and non-transitory computer-readable medium described herein, the local-based request includes an internally originated request of the network agent.

In some examples of the method, network agents, and non-transitory computer-readable medium described herein, the cloud-based request includes an identifier corresponding to a network function associated with a network device of the private cellular network, and the local-based request includes one or more local credentials in accordance with a mapping of the one or more local credentials to the identifier corresponding to the network function.

Another innovative aspect of the subject matter described in this disclosure can be implemented at a method for wireless communications by a network agent. The method may include obtaining, from a cloud network controller, a cloud-based request for one or more network parameters associated with one or more cloud network credentials that correspond to a private cellular network associated with the network agent, outputting a local-based request in accordance with the cloud-based request and one or more local credentials of a network device of the private cellular network that are different from the one or more cloud network credentials, obtaining, from the network device of the private cellular network, a local-based response to the local-based request that includes the one or more network parameters, and outputting a cloud-based response indicating at least a portion of the one or more network parameters, where the cloud-based response omits at least a portion of the one or more local credentials of the network device of the private cellular network.

Another innovative aspect of the subject matter described in this disclosure can be implemented at a network agent for wireless communications. The network agent may include a processing system that includes processor circuitry that stores code, the processing system configured to cause the network agent to obtain, from a cloud network controller, a cloud-based request for one or more network parameters associated with one or more cloud network credentials that correspond to a private cellular network associated with the network agent, output a local-based request in accordance with the cloud-based request and one or more local credentials of a network device of the private cellular network that are different from the one or more cloud network credentials, obtain, from the network device of the private cellular network, a local-based response to the local-based request that includes the one or more network parameters, and output a cloud-based response indicating at least a portion of the one or more network parameters, where the cloud-based response omits at least a portion of the one or more local credentials of the network device of the private cellular network.

In some examples of the method, network agents, and non-transitory computer-readable medium described herein, the cloud-based request includes an identifier corresponding to a network function associated with the network device of the private cellular network, and the local-based request and the local-based response include one or more local credentials in accordance with a mapping of the one or more local credentials to the identifier corresponding to the network function.

In some examples of the method, network agents, and non-transitory computer-readable medium described herein, the cloud-based request indicates a request for a cell configuration of the private cellular network and the one or more network parameters indicated in the cloud-based response include the cell configuration.

In some examples of the method, network agents, and non-transitory computer-readable medium described herein, the one or more local credentials omitted from the cloud-based response include cell credentials and connectivity information associated with the private cellular network.

Another innovative aspect of the subject matter described in this disclosure can be implemented in a method for wireless communications at a cloud network controller. The method may include outputting a cloud-based request requesting one or more network parameters associated with one or more cloud network credentials that correspond to a private cellular network and obtaining, from a network agent associated with the private cellular network, a cloud-based response indicating at least a portion of the one or more network parameters, where the cloud-based response omits at least a portion of one or more local credentials of the private cellular network.

Another innovative aspect of the subject matter described in this disclosure can be implemented at a cloud network controller for wireless communications. The cloud network controller may include a processing system that includes processor circuitry that stores code, the processing system configured to cause the cloud network controller to output a cloud-based request requesting one or more network parameters associated with one or more cloud network credentials that correspond to a private cellular network and obtain, from a network agent associated with the private cellular network, a cloud-based response indicating at least a portion of the one or more network parameters, where the cloud-based response omits at least a portion of one or more local credentials of the private cellular network.

In some examples of the method, cloud network controllers, and non-transitory computer-readable medium described herein, the cloud-based request indicates an identifier corresponding to a network function associated with a network device of the private cellular network.

In some examples of the method, cloud network controllers, and non-transitory computer-readable medium described herein, the one or more local credentials omitted from the cloud-based response include cell credentials and connectivity information associated with the private cellular network.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example of a wireless communications system that supports centralized management cloud connecting multiple enterprise networks.

FIG. 2 shows an example of a cloud network architecture that supports centralized management cloud connecting multiple enterprise networks.

FIG. 3 shows an example of a cloud network signaling diagram that supports centralized management cloud connecting multiple enterprise networks.

FIG. 4 shows an example of a cloud network signaling diagram that supports centralized management cloud connecting multiple enterprise networks.

FIG. 5 shows an example of a cloud network architecture that supports centralized management cloud connecting multiple enterprise networks.

FIG. 6 shows an example of a method that supports centralized management cloud connecting multiple enterprise networks.

FIG. 7 shows a block diagram of a communications manager that supports centralized management cloud connecting multiple enterprise networks.

FIG. 8 shows a diagram of a system including a device that supports centralized management cloud connecting multiple enterprise networks.

FIGS. 9-11 shows flowcharts illustrating methods that support centralized management cloud connecting multiple enterprise networks.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing third generation (3G), fourth generation (4G), fifth generation (5G), or sixth generation (6G), or further implementations thereof, technology.

Private cellular networks are deployed in support of various scenarios. Such private cellular networks may be deployed within a factory setting or across multiple factories to support communications between sensors, machines, robots, or other automation technologies. Deployment of private cellular networks requires hardware deployment to include configuration and management of cellular communication devices that are compliant with traditional cellular networks. This can result in a significant increase in costs and complexity of private cellular network deployments as the technical expertise relating to cellular communications networks is extensive. To mitigate this, some private cellular networks are remotely managed over a public network (such as the Internet). The private cellular network operator or the managing operator may deploy the hardware and software components of the private cellular network and the network may be managed remotely. The remote manager may log in or otherwise access the private cellular network over the public network to check or update the cell configuration, to install or retire nodes within the network, as well as to perform other functions. Such remote systems expose the private cellular network to increased security risks and vulnerabilities. The remote manager may not otherwise be associated with the private cellular network but may still have access to all information relating to the private cellular network itself as well as the information being communicated over the private cellular network. The remote management of the private cellular network over the public network exposes both parties to hacking or other security vulnerabilities.

Aspects of the described techniques provide for an architecture that enables a secure private cellular network to link to or otherwise connect to a centralized cloud management service. The architecture may improve security of the private cellular network by masking (such as hiding or obscuring) credentials and other information of the private cellular network from the cloud management service. The described techniques provide a mechanism where the private cellular network equipment is built from or otherwise associated with network function(s) that form software building blocks of the private cellular network. This may use a network agent that is, in some aspects, a software program or function that is operating on the premises of and part of the private cellular network. The network agent masks the credentials, information, or other private information of or within the private cellular network (such as for each network function within the private cellular network) from the cloud and the public network. The network agent may, although collocated with the private cellular network, host the credentials and local internet protocol (IP) addresses of the network function(s) of the private cellular network without sharing this information with the cloud services.

The network agent may receive or otherwise obtain a cloud-based request from the cloud network controller. The cloud-based request may be for one or more network parameters associated with cloud network credentials of the network agent that correspond to the private cellular network associated with the network agent. The network agent may output a local-based request in accordance with the cloud-based request and one or more local credentials of a network device of the private cellular network that are different from the one or more cloud network credentials of the network agent. The network agent may obtain, from the network device of the private cellular network, a local-based response to the local-based request identifying the one or more network parameters. The network agent may output a cloud-based response indicating at least a portion of the one or more network parameters. The cloud-based response may omit at least a portion of the one or more local credentials of the network device of the private cellular network. The cloud-based response may omit various cell credentials, connectivity information or other private information associated with the private cellular network. This may provide for the cloud network controller to discover new node(s) in the private cellular network (such as a request to learn or discover the inventory of the private cellular network), to enable file uploads from the network agent to be shared with the cloud network controller, to be informed regarding or otherwise discover alarms or other events sent from the network function to the cloud network controller via the network agent, among other features.

Particular implementations of the subject matter described in this disclosure can be implemented to realize one or more of the following potential advantages. Aspects of the described techniques may enable a management system that is able to manage different radio access network (RAN) functions without the knowledge of the management protocol and underlying security protocols/credentials. The data separation aspects of the described techniques may enable the data separation between the local network agent and the cloud to allow the benefit of a software as a service (SaaS) functionality without the risk of a data breach. Aspects of the techniques described herein may enable the remote management of a private cellular network but without the complexity, expense, and vulnerabilities of a virtual private cloud (VPC), virtual private network (VPN), or other secure tunnel connection. Instead, aspects of the techniques described herein may adopt cellular network functionality to support the remote management aspects (such as Internet-of-Things (IoT) technologies). The described techniques may enable private radio access network connectivity to the cloud services to support network management in a periodic basis (such as using push messages) or on a request basis (such as using pull messages). The described architecture may provide for effective control of multiple private cellular networks in a manner that protects the privacy of each private cellular network. The described architecture may provide for an efficient mechanism to orchestrate software models on the isolated premises of the customer (such as the private cellular network operator) to support software lifecycle management. This prevents the cloud network controller as well as any potential hacker from discovering private information related to or within the private cellular network.

The techniques described herein may enable plug-n-play installation and setup of new private cellular networks and new node(s) within the private cellular networks (such as without on-premises installation of the management platform). The described architecture may provide for remote management for off-the-shelf and open-radio access network (O-RAN) compliant RAN equipment (such as off-the-shelf equipment often implements management protocols that are not suitable for remote wide area network (WAN) connections). The described architecture may support such equipment without requiring any changes (such as off-the-shelf protocols to pass through routers, secure tunnels, firewalls) and the support for multicast, broadcast, and virtual local area network (v-LAN) aspects of the communications. The described architecture may provide for software-as-a-service (Saas) provider updates, upgrades, and support for the management platform where payment is on a pay-as-you-grow model (such as avoiding the upfront costs of management platform acquisition, implementation, and integration).

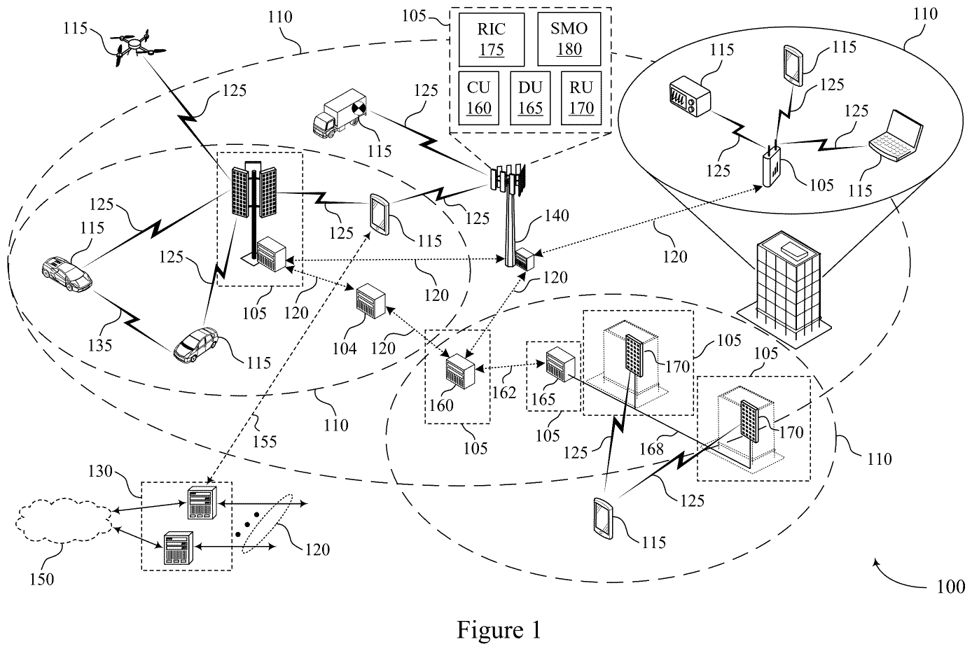

FIG. 1 shows an example of a wireless communications system 100 that supports centralized management cloud connecting multiple enterprise networks. The wireless communications system 100 may include one or more network entities 105, one or more UEs 115, and a core network 130. In some implementations, the wireless communications system 100 may be a Long-Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some implementations, network entities 105 and UEs 115 may wirelessly communicate via one or more communication links 125 (such as a radio frequency (RF) access link). For example, a network entity 105 may support a coverage area 110 (such as a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some implementations, network entities 105 may communicate with the core network 130, or with one another, or both. For example, network entities 105 may communicate with the core network 130 via one or more backhaul communication links 120 (such as in accordance with an S1, N2, N3, or other interface protocol). In some implementations, network entities 105 may communicate with one another via a backhaul communication link 120 (such as in accordance with an X2, Xn, or another interface protocol) either directly (such as directly between network entities 105) or indirectly (such as via a core network 130). In some implementations, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication links 120, midhaul communication links 162, or fronthaul communication links 168 may be or include one or more wired links (such as an electrical link, an optical fiber link), one or more wireless links (such as a radio link, a wireless optical link), among other examples or various combinations thereof. A UE 115 may communicate with the core network 130 via a communication link 155.

One or more of the network entities 105 described herein may include or may be referred to as a base station (BS) 140 (such as a base transceiver station, a radio BS, an NR BS, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some implementations, a network entity 105 (such as a BS 140) may be implemented in an aggregated (such as monolithic, standalone) BS architecture, which may be configured to utilize a protocol stack that is physically or logically integrated within a single network entity 105 (such as a single RAN node, such as a BS 140).

In some implementations, a network entity 105 may be implemented in a disaggregated architecture (such as a disaggregated BS architecture, a disaggregated RAN architecture), which may be configured to utilize a protocol stack that is physically or logically distributed among two or more network entities 105, such as an integrated access backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU) 160, a distributed unit (DU) 165, a radio unit (RU) 170, a RAN Intelligent Controller (RIC) 175 (such as a Near-Real Time RIC (Near-RT RIC), a Non-Real Time RIC (Non-RT RIC)), a Service Management and Orchestration (SMO) 180 system, or any combination thereof. An RU 170 also may be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some implementations, one or more network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending on which functions (such as network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some implementations, the CU 160 may host upper protocol layer (such as layer 3 (L3), layer 2 (L2)) functionality and signaling (such as Radio Resource Control (RRC), service data adaptation protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (such as physical (PHY) layer) or L2 (such as radio link control (RLC) layer, medium access control (MAC) layer) functionality and signaling and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or more RUs 170). In some implementations, a functional split between a CU 160 and a DU 165, or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (such as F1, F1-c, F1-u), and a DU 165 may be connected to one or more RUs 170 via a fronthaul communication link 168 (such as open fronthaul (FH) interface). In some implementations, a midhaul communication link 162 or a fronthaul communication link 168 may be implemented in accordance with an interface (such as a channel) between layers of a protocol stack supported by respective network entities 105 that are in communication via such communication links.

In wireless communications systems (such as wireless communications system 100), infrastructure and spectral resources for radio access may support wireless backhaul link capabilities to supplement wired backhaul connections, providing an IAB network architecture (such as to a core network 130). In some implementations, in an IAB network, one or more network entities 105 (such as IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (such as a donor BS 140). The one or more donor network entities 105 (such as IAB donors) may be in communication with one or more additional network entities 105 (such as IAB nodes 104) via supported access and backhaul links (such as backhaul communication links 120). IAB nodes 104 may include an IAB mobile termination (IAB-MT) controlled (such as scheduled) by DUs 165 of a coupled IAB donor. An IAB-MT may include an independent set of antennas for relay of communications with UEs 115 or may share the same antennas (such as of an RU 170) of an IAB node 104 used for access via the DU 165 of the IAB node 104 (such as referred to as virtual IAB-MT (VIAB-MT)). In some implementations, the IAB nodes 104 may include DUs 165 that support communication links with additional entities (such as IAB nodes 104, UEs 115) within the relay chain or configuration of the access network (such as downstream). In such implementations, one or more components of the disaggregated RAN architecture (such as one or more IAB nodes 104 or components of IAB nodes 104) may be configured to operate according to the techniques described herein.

For instance, an access network (AN) or RAN may include communications between access nodes (such as an IAB donor), IAB nodes 104, and one or more UEs 115. The IAB donor may facilitate connection between the core network 130 and the AN (such as via a wired or wireless connection to the core network 130). That is, an IAB donor may refer to a RAN node with a wired or wireless connection to core network 130. The IAB donor may include a CU 160 and at least one DU 165 (such as and RU 170), for which the CU 160 may communicate with the core network 130 via an interface (such as a backhaul link). IAB donor and IAB nodes 104 may communicate via an F1 interface according to a protocol that defines signaling messages (such as an F1 AP protocol). Additionally, or alternatively, the CU 160 may communicate with the core network via an interface, which may be an example of a portion of backhaul link and may communicate with other CUs 160 (such as a CU 160 associated with an alternative IAB donor) via an Xn-C interface, which may be an example of a portion of a backhaul link.

An IAB node 104 may refer to a RAN node that provides IAB functionality (such as access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (such as an IAB donor may relay transmissions for UEs through one or more other IAB nodes 104). Additionally, or alternatively, an IAB node 104 also may be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (such as DUs 165) may provide a Uu interface for a parent IAB node 104 to signal to a child IAB node 104 or UE 115.

For example, IAB node 104 may be referred to as a parent node that supports communications for a child IAB node or referred to as a child IAB node associated with an IAB donor, or both. The IAB donor may include a CU 160 with a wired or wireless connection (such as a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (such as transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the implementation of the techniques described herein applied in the context of a disaggregated RAN architecture, one or more components of the disaggregated RAN architecture may be configured to support centralized management cloud connecting multiple enterprise networks as described herein. For example, some operations described as being performed by a UE 115 or a network entity 105 (such as a BS 140) may additionally, or alternatively, be performed by one or more components of the disaggregated RAN architecture (such as IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay BSs, among other examples, as shown in FIG. 1.

The UEs 115 and the network entities 105 may wirelessly communicate with one another via one or more communication links 125 (such as an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (such as a bandwidth part (BWP)) that is operated according to one or more physical layer channels for a given radio access technology (such as LTE, LTE-A, LTE-A Pro, NR). Each physical layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a BS 140, a CU 160, a DU 165, a RU 170) of a RAN communicating with another device (such as directly or via one or more other network entities 105).

In some implementations, such as in a carrier aggregation configuration, a carrier also may have acquisition signaling or control signaling that coordinates operations for other carriers. A carrier may be associated with a frequency channel (such as an evolved universal mobile telecommunication system terrestrial radio access (E-UTRA) absolute RF channel number (EARFCN)) and may be identified according to a channel raster for discovery by the UEs 115. A carrier may be operated in a standalone mode, for which initial acquisition and connection may be conducted by the UEs 115 via the carrier, or the carrier may be operated in a non-standalone mode, for which a connection is anchored using a different carrier (such as of the same or a different radio access technology).

The communication links 125 shown in the wireless communications system 100 may include downlink transmissions (such as forward link transmissions) from a network entity 105 to a UE 115, uplink transmissions (such as return link transmissions) from a UE 115 to a network entity 105, or both, among other configurations of transmissions. Carriers may carry downlink or uplink communications (such as in an FDD mode) or may be configured to carry downlink and uplink communications (such as in a TDD mode).

A carrier may be associated with a particular bandwidth of the RF spectrum and, in some implementations, the carrier bandwidth may be referred to as a “system bandwidth” of the carrier or the wireless communications system 100. For example, the carrier bandwidth may be one of a set of bandwidths for carriers of a particular radio access technology (such as 1.4, 3, 5, 10, 15, 20, 40, or 80 megahertz (MHz)). Devices of the wireless communications system 100 (such as the network entities 105, the UEs 115, or both) may have hardware configurations that support communications using a particular carrier bandwidth or may be configurable to support communications using one of a set of carrier bandwidths. In some implementations, the wireless communications system 100 may include network entities 105 or UEs 115 that support concurrent communications using carriers associated with multiple carrier bandwidths. In some implementations, each served UE 115 may be configured for operating using portions (such as a sub-band, a BWP) or all of a carrier bandwidth.

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, for which the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communications resource may refer to a combination of an RF spectrum resource, a time resource, and a spatial resource (such as a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some implementations, a UE 115 may be configured with multiple BWPs. In some implementations, a single BWP for a carrier may be active at a given time and communications for the UE 115 may be restricted to one or more active BWPs.

The time intervals for the network entities 105 or the UEs 115 may be expressed in multiples of a basic time unit which may, in some implementations, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively numbered subframes or slots, and each subframe or slot may have the same duration. In some implementations, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some implementations, the TTI duration (such as a quantity of symbol periods in a TTI) may be variable. Additionally, or alternatively, the smallest scheduling unit of the wireless communications system 100 may be dynamically selected (such as in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (such as using a carrier) and may be associated with an identifier for distinguishing neighboring cells (such as a physical cell identifier (PCID), a virtual cell identifier (VCID), or others). In some implementations, a cell also may refer to a coverage area 110 or a portion of a coverage area 110 (such as a sector) over which the logical communication entity operates. Such cells may range from smaller areas (such as a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell covers a relatively large geographic area (such as several kilometers in radius) and may allow unrestricted access by the UEs 115 with service subscriptions with the network provider supporting the macro cell. A small cell may be associated with a lower-powered network entity 105 (such as a lower-powered BS 140), as compared with a macro cell, and a small cell may operate using the same or different (such as licensed, unlicensed) frequency bands as macro cells. Small cells may provide unrestricted access to the UEs 115 with service subscriptions with the network provider or may provide restricted access to the UEs 115 having an association with the small cell (such as the UEs 115 in a closed subscriber group (CSG), the UEs 115 associated with users in a home or office). A network entity 105 may support one or multiple cells and also may support communications via the one or more cells using one or multiple component carriers.

In some implementations, a carrier may support multiple cells, and different cells may be configured according to different protocol types (such as MTC, narrowband IoT (NB-IOT), enhanced mobile broadband (eMBB)) that may provide access for different types of devices.

In some implementations, a network entity 105 (such as a BS 140, an RU 170) may be movable and therefore provide communication coverage for a moving coverage area 110. In some implementations, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (such as BSs 140) may have similar frame timings, and transmissions from different network entities 105 may be approximately aligned in time. For asynchronous operation, network entities 105 may have different frame timings, and transmissions from different network entities 105 may, in some implementations, not be aligned in time. The techniques described herein may be used for either synchronous or asynchronous operations.

Some UEs 115, such as MTC or IoT devices, may be low cost or low complexity devices and may provide for automated communication between machines (such as via Machine-to-Machine (M2M) communication). M2M communication or MTC may refer to data communication technologies that allow devices to communicate with one another or a network entity 105 (such as a BS 140) without human intervention. In some implementations, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (such as a mode that supports one-way communication via transmission or reception, but not transmission and reception concurrently). In some implementations, half-duplex communications may be performed at a reduced peak rate. Other power conservation techniques for the UEs 115 include entering a power saving deep sleep mode when not engaging in active communications, operating using a limited bandwidth (such as according to narrowband communications), or a combination of these techniques. For example, some UEs 115 may be configured for operation using a narrowband protocol type that is associated with a defined portion or range (such as set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some implementations, a UE 115 may be configured to support communicating directly with other UEs 115 via a device-to-device (D2D) communication link 135 (such as in accordance with a peer-to-peer (P2P), D2D, or sidelink protocol). In some implementations, one or more UEs 115 of a group that are performing D2D communications may be within the coverage area 110 of a network entity 105 (such as a BS 140, an RU 170), which may support aspects of D2D communications being configured by (such as scheduled by) the network entity 105. In some implementations, one or more UEs 115 of a group may be outside the coverage area 110 of a network entity 105 or may be otherwise unable to or not configured to receive transmissions from a network entity 105. In some implementations, groups of the UEs 115 communicating via D2D communications may support a one-to-many (1:M) system in which each UE 115 transmits to each of the other UEs 115 in the group. In some implementations, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (such as UEs 115). In some implementations, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some implementations, vehicles in a V2X system may communicate with roadside infrastructure, such as roadside units, or with the network via one or more network nodes (such as network entities 105, BSs 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as BSs 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communication using UHF waves may be associated with smaller antennas and shorter ranges (such as less than 100 kilometers) compared to communications using the smaller frequencies and longer waves of the high frequency (HF) or very high frequency (VHF) portion of the spectrum below 300 MHz.

The wireless communications system 100 also may operate using a super high frequency (SHF) region, which may be in the range of 3 GHz to 30 GHz, also known as the centimeter band, or using an extremely high frequency (EHF) region of the spectrum (such as from 30 GHz to 300 GHz), also known as the millimeter band. In some implementations, the wireless communications system 100 may support millimeter wave (mmW) communications between the UEs 115 and the network entities 105 (such as BSs 140, RUs 170), and EHF antennas of the respective devices may be smaller and more closely spaced than UHF antennas. In some implementations, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some implementations, operations using unlicensed bands may be associated with a carrier aggregation configuration in conjunction with component carriers operating using a licensed band (such as LAA). Operations using unlicensed spectrum may include downlink transmissions, uplink transmissions, P2P transmissions, or D2D transmissions, among other examples.

A network entity 105 (such as a BS 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (such as the same codeword) or different data streams (such as different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which also may be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

A network entity 105 or a UE 115 may use beam sweeping techniques as part of beamforming operations. For example, a network entity 105 (such as a BS 140, an RU 170) may use multiple antennas or antenna arrays (such as antenna panels) to conduct beamforming operations for directional communications with a UE 115. Some signals (such as synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (such as by a transmitting device, such as a network entity 105, or by a receiving device, such as a UE 115) a beam direction for later transmission or reception by the network entity 105.

Some signals, such as data signals associated with a particular receiving device, may be transmitted by transmitting device (such as a transmitting network entity 105, a transmitting UE 115) along a single beam direction (such as a direction associated with the receiving device, such as a receiving network entity 105 or a receiving UE 115). In some implementations, the beam direction associated with transmissions along a single beam direction may be determined associated with a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some implementations, transmissions by a device (such as by a network entity 105 or a UE 115) may be performed using multiple beam directions, and the device may use a combination of digital precoding or beamforming to generate a combined beam for transmission (such as from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (such as a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (such as a multi-panel type codebook, a linear combination type codebook, a port selection type codebook). Although these techniques are described with reference to signals transmitted along one or more directions by a network entity 105 (such as a BS 140, an RU 170), a UE 115 may employ similar techniques for transmitting signals multiple times along different directions (such as for identifying a beam direction for subsequent transmission or reception by the UE 115) or for transmitting a signal along a single direction (such as for transmitting data to a receiving device).

A receiving device (such as a UE 115) may perform reception operations in accordance with multiple receive configurations (such as directional listening) when receiving various signals from a transmitting device (such as a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (such as different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some implementations, a receiving device may use a single receive configuration to receive along a single beam direction (such as when receiving a data signal). The single receive configuration may be aligned along a beam direction determined associated with listening according to different receive configuration directions (such as a beam direction determined to have a highest signal strength, highest signal-to-noise ratio (SNR), or otherwise acceptable signal quality associated with listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (such as a communication link 125, a D2D communication link 135). HARQ may include a combination of error detection (such as using a cyclic redundancy check (CRC)), forward error correction (FEC), and retransmission (such as automatic repeat request (ARQ)). HARQ may improve throughput at the MAC layer in poor radio conditions (such as low signal-to-noise conditions). In some implementations, a device may support same-slot HARQ feedback, for which the device may provide HARQ feedback in a specific slot for data received via a previous symbol in the slot. In some other examples, the device may provide HARQ feedback in a subsequent slot, or according to some other time interval.

A network agent may obtain a local-based request to initiate a cloud-based procedure associated with one or more network parameters, the one or more network parameters are associated with one or more cloud network credentials that correspond to a private cellular network. The network agent may output a cloud-based request to initiate the cloud-based procedure in accordance with the local-based request, the cloud-based request indicates at least a portion of the one or more network parameters and omits at least a portion of one or more local credentials of the private cellular network.

A network agent may obtain, from a cloud network controller, a cloud-based request for one or more network parameters associated with one or more cloud network credentials that correspond to a private cellular network associated with the network agent. The network agent may output a local-based request in accordance with the cloud-based request and one or more local credentials of a network device of the private cellular network that are different from the one or more cloud network credentials. The network agent may obtain, from the network device of the private cellular network, a local-based response to the local-based request that includes the one or more network parameters. The network agent may output a cloud-based response indicating at least a portion of the one or more network parameters, the cloud-based response omits at least a portion of the one or more local credentials of the network device of the private cellular network.

A cloud network controller may output a cloud-based request requesting one or more network parameters associated with one or more cloud network credentials that correspond to a private cellular network. The cloud network controller may obtain, from a network agent associated with the private cellular network, a cloud-based response indicating at least a portion of the one or more network parameters, the cloud-based response omits at least a portion of one or more local credentials of the private cellular network.

The architecture described herein provides for remote management of a private cellular network (such as the wireless communications system 100) in a manner that protects the private information (such as the local credentialing information, security information, signaling information, or other similar information) of the private cellular network from cyber-attacks or hacking. The network agent may be deployed within the private cellular network (such as being part of a network entity 105) and communication with the network functions within the private cellular network using local-based request(s) or response(s). The local-based request(s) or response(s) may use the private information of the private cellular network. The network agent also may communicate with the cloud network controller via a public network (such as the internet) using cloud-based request(s) or response(s). The cloud-based request(s) or response(s) may share some of the network parameters of the private cellular network (such as the information used to initialize nodes within the private cellular network, to update those nodes, to manage operations of those nodes, or to retire such nodes). The cloud-based request(s) or response(s) may, however, omit or otherwise hide various credentialing information (such as by not including the credentialing or other private information) of the private cellular network.

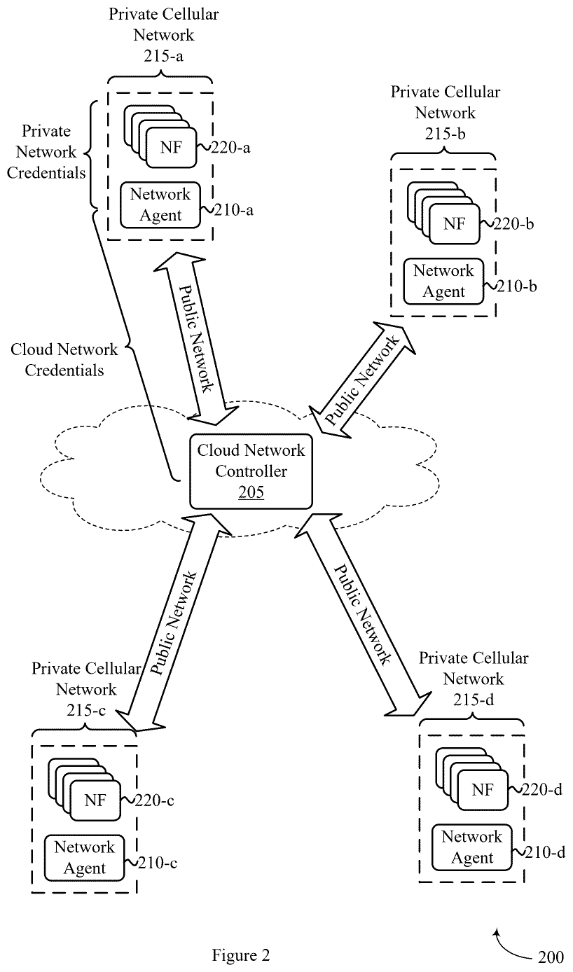

FIG. 2 shows an example of a cloud network architecture 200 that supports centralized management cloud connecting multiple enterprise networks. The cloud network architecture 200 may implement aspects of or be implemented by aspects of wireless communications system 100 described with reference to FIG. 1. The cloud network architecture 200 may include a cloud network controller 205, a network agent 210, a private cellular network 215, and a network function 220, which may be examples of the corresponding devices described herein. The cloud network controller 205 may be an example of a cloud-based service that remotely manages aspects of one or more of a private cellular network 215. Each private cellular network 215 may include a network agent 210 and one or more of the network functions 220.

Aspects of the techniques described herein provide for a new architecture to connect multiple enterprise networks (such as private cellular networks) with or to a centralized management cloud (such as a cloud network controller). Aspects of the architecture described herein provides a secure private cellular network link to the centralized cloud management (such as supports security by hiding private details and information and the security credentials of the private cellular network from the cloud). Aspects of the architecture described herein provides for effective control of multiple distributed private cellular networks (such as supports communications between the cloud and the private cellular networks). Aspects of the architecture described herein provides for effective orchestration of the software models on the customer isolated premises (such as supports software lifecycle management within the private cellular network).

The architecture described herein provide for private cellular network equipment to be built from network function(s) (NF)(s) which are software building blocks of the RAN. A network agent 210 may be an example of a software program that is running on the premises at the customer site and part of the local private cellular network. The network agent 210 may mask, hide, or otherwise shield (such as by masking or hiding) private information (such as credentials) of the network function(s) (such as one or more of the network functions 220). The network agent 210, which may be on the premises and part of the private cellular network, may host the credentials and local IP addresses of the RAN network function(s) 220 without sharing this information with the cloud services (such as with the cloud network controller 205).

Private cellular network(s) (such as one or more of the private cellular network 215) may be built from network function(s) (such as one or more of the network functions 220) which are software building blocks of the RAN (such as the private cellular network 215). The network agent 210 may be an example of a software that is running on premises at the customer site and part of the local private cellular network (such as the private cellular network 215). The network agent 210 may host the credentials and local IP addresses of the RAN network function(s) without exposing this information to the cloud-services (such as by not including this information in messages exchanged with the cloud network controller 205). The network agent 210 may be responsible to the network function 220. The network agent 210 may obscure the management protocol for the RAN, such as the network configuration protocol (Netconf), the simple network management protocol (SNMP), technical report 069 (TR-069), representational state transfer (REST) architecture, or other means or mechanisms. The cloud network controller 205 (such as the cloud service) may be aware of the network function identifier and, using a unique mechanism to load the network function configuration from the network agent to the cloud without knowing the network function credentials. Individual devices (such as UEs) may be protected and isolated with the private cellular network 215 as the network agent 210 accesses the nodes (such as the network function associated with a network device entity or device within the private cellular network).

Accordingly, the architecture described herein provides a mechanism for information exchange, initialization, life-cycle management, or other feature or function that enables deployment of the private cellular network in a secure manner. The network agent 210 may act as a wall or interface between the RAN (such as the various network entities or devices within the private cellular network) and the cloud services that permits the remote initialization, monitoring, updates, or other management related features to support the RAN while masking or otherwise hiding the private information or details of the RAN from the cloud (and being communicated over a public network, such as the internet). The described architecture provide the management system (such as the cloud network controller 205) to be able to manage different RAN functions without the knowledge of the management protocol and underlying security credentials and protocols. This data separation between the network agent 210 and the cloud network controller 205 supports the benefits of a software as a service (Saas) functionality but without the risk of a data breach.

The network agent 210 that is on premises with or otherwise located at (such as associated with) a private cellular network 215 communicating with the cloud network controller 205 over a public network. The network agent 210-a may be associated with the private cellular network 215-a, the network agent 210-b may be associated with the private cellular network 215-b, the network agent 210-c associated with the private cellular network 215-c, and the network agent 210-d associated with the private cellular network 215-d. However, it is to be understood that the cloud network controller 205 may be associated with (such as remotely manage) aspects of a larger number or quantity of private cellular networks over the public network (such as the internet). In some aspects, each private cellular network 215 may have one or more network function 220 that are each associated with one or more corresponding network entities or devices or other network operation within the private cellular network 215. The private cellular network 215-a may provide the network function 220-a, the private cellular network 215-b may provide the network function 220-b, the private cellular network 215-c may provide the network function 220-c, and the private cellular network 215-d may provide the network function 220-d.

The network agent 210 within each private cellular network 215 may act as an interface between the one or more of the network functions 220 of the private cellular network 215 and the cloud network controller 205 over a public network. The network agent 210 may mask or hide private information, security information, or details related to each network function 220 from being exposed to the public network (such as the internet) or the cloud network controller 205. This is based on messages exchanged between the network agent 210 and the cloud network controller 205 (such as which may be referred to as cloud-based requests or responses) as well as between the network agent 210 and the network function 220 (such as which may be referred to as local-based requests or responses). In some aspects, the cloud-based requests or the cloud-based responses may omit, mask, or otherwise hide local credentials of the private cellular network 215.

The network agent 210 receiving or otherwise obtaining a local-based request to initiate a cloud-based procedure associated with network parameter(s). The network parameter(s) may be associated with cloud network credentials that correspond to or are otherwise associated with the private cellular network 215. The local-based request may include the network agent 210 receiving or otherwise obtaining the local-based request from a network device (such as a network function 220 associated with the network entity or device) that triggers the cloud-based procedure with the cloud network controller 205. Additionally, or alternatively, the local-based request may be internally or autonomously originated by the network agent 210. Accordingly, the network agent 210 may transmit or otherwise output a cloud-based request to initiate the cloud-based procedure according to the local-based request. The cloud-based request may indicate at least a portion of the network parameter(s) while omitting at least a portion of local credential(s) of the private cellular network 215.

The local-based request(s) or response(s) may include local credential(s) associated with a mapping of the local credential(s) to an identifier corresponding to the network function 220 associated with the network entity or device of the private cellular network 215. The cloud-based request(s) or response(s) may carry or otherwise include an indication of the identifier. The identifier of the network function 220 or an identifier associated with the network function 220 may be mapped to the network function 220 (or the network device associated with the network function 220) and used for identification of the network function 220 in communications with the cloud network controller 205. The identifier being mapped to the network function 220 may be used in the cloud-based request(s) or response(s) to link the cloud-based procedure to the network function 220. The cloud-based procedure may include any procedure where the network entity or device associated with the identifier is managed (such as initialized, updated, deleted, or otherwise monitored) by the cloud network controller 205 via the network agent 210.

Additionally, or alternatively, the network agent 210 may receive or otherwise obtain (and the cloud network controller 205 may transmit or otherwise output) a cloud-based request for network parameter(s) associated with cloud network credentials that correspond to the private cellular network 215 associated with the network agent 210. The cloud-based request may be received or otherwise obtained from the cloud network controller 205 (such as via the public network, such as the internet). In some aspects, the cloud network credentials exchanged over the public network may include the identifier associated with a network function 220 corresponding to the network entity or device. The network agent 210 may transmit or otherwise output a local-based request according to the cloud-based request and local credential(s) of the network device of the private cellular network 215 that are different from the cloud network credential(s). The local credential(s) may include various parameters, credentials, security information, or other private information associated with the network function 220 or the private cellular network 215. The network agent 210 may receive or otherwise obtain a local-based response from the network device (such as the network function 220) according to the local-based request that includes the network parameter(s). Accordingly, the network agent 210 may transmit or otherwise output (and the cloud network controller 205 may receive or otherwise obtain) a cloud-based response to the cloud network controller 205 that indicates at least a portion of the network parameter(s) and omits at least a portion of the local credential(s) of the network device of the private cellular network 215.

As is shown in FIG. 2, the local-based request(s) or response(s) exchanged between the network function 220 and the network agent 210 may use various private cellular network parameters or credentials that may be associated with the identifier. However, any cloud-based request(s) or response(s) exchanged between the network agent 210 and the cloud network controller 205 may use various cloud network parameters or credentials that are also associated with the identifier. The various cloud network parameters or credentials may omit some or all of the private cellular network parameters or credentials (such as the network agent 210 may mask, hide, or otherwise omit some or all of the private cellular network parameters or credentials associated with the network function 220 or the private cellular network 215). Accordingly, such private cellular network parameters or credentials are not exchanged with the cloud network controller 205 via the public network such that a data breach cannot occur with respect to the private cellular network 215. In some aspects, the local credential(s) omitted from the cloud-based requests or responses may include various cell credentials and connectivity information associated with the private cellular network 215. The cell credentials and connectivity information may include any private information of the private cellular network 215 that is to be maintained as or otherwise designated as private information of the private cellular network 215. Such as any credentialing information, security information or keys, cellular traffic information being exchanged over the RAN, information relating to or otherwise identifying the nodes operating within the RAN, or other information that is considered private or proprietary by the operator of the private cellular network 215.

In an example where the cloud-based procedure includes the cloud network controller 205 performing a read function from the private cellular network 215, the network parameters indicated in the cloud-based request(s) or response(s) (such as the cloud network credentials) may include a cell configuration associated with the private cellular network 215. The cloud (such as the cloud network controller 205) may initiate a request to load the 5G cell configuration from the private cellular network 215 to the cloud without knowing or learning the cell credentials and connectivity information of the private cellular network 215. In this implementation, the network parameter(s) indicated in the cloud-based request(s) or response(s) may include the cell configuration of the private cellular network 215.

In an example where the cloud-based procedure includes the cloud network controller 205 writing information to the private cellular network 215, the cloud-based request(s) or response(s) may include a cell configuration that configures the 5G cell. In this example, the cloud network controller 205 may configure the 5G cell without knowing the cell credentials or connectivity information of the private cellular network 215. The cloud-based request(s) or response(s) may indicate the cell configuration of the private cellular network 215. Moreover, the network parameter(s) indicated in the cloud-based request(s) or response(s) may include the cell configuration of the private cellular network 215.

In an example where the cloud-based procedure includes the cloud network controller 205 discovering new 5G nodes in the private cellular network 215, the network parameters indicated in the cloud-based request(s) or response(s) may include a cell node update or confirmation of a cell node update associated with the private cellular network 215. The cloud may initiate a request to learn the inventory of the private cellular network 215 and the private cellular network 215 (such as via the network agent 210) may provide the cell node update information to the cloud network controller 205 without disclosing any credentials or other information that may be used to penetrate the private cellular network 215. The private cellular network 215 (such as via the network agent 210) may initiate a command (such as the local based request or response) to make the cloud aware of any changes to the private cellular network 215. Accordingly, the cloud-based request(s) or response(s) may include a request for the cell node update associated with the private cellular network 215.

Although the examples discussed above may include the cloud network controller 205 initiating the procedures with the private cellular network 215 via the network agent 210, it is to be understood that the network agent 210 may initiate the connectivity service through a firewall to the cloud network controller 205 in order to retrieve the cloud-based request(s) or response(s) of the cloud network controller 205.

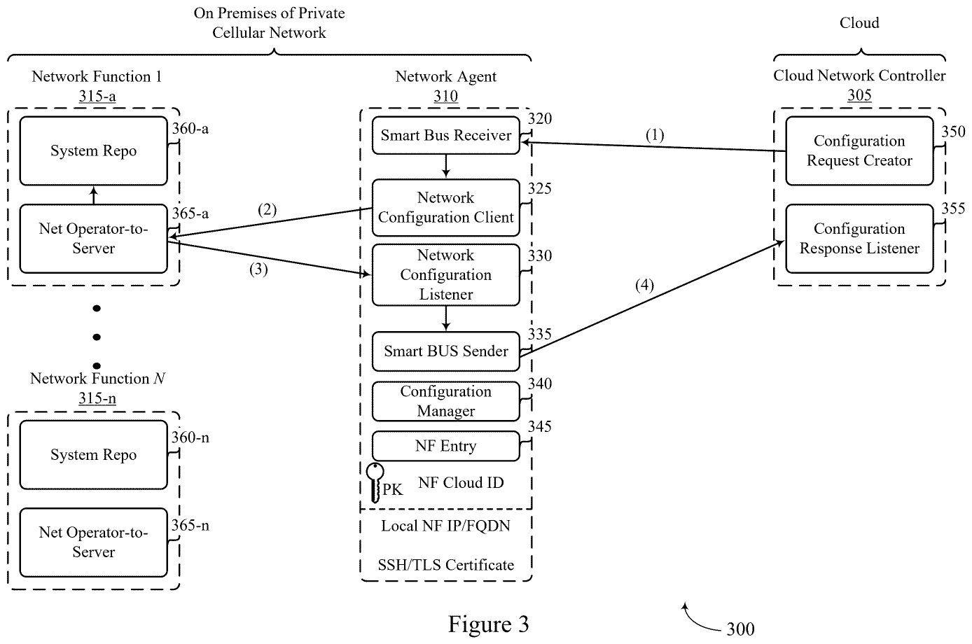

FIG. 3 shows an example of a cloud network signaling diagram 300 that supports centralized management cloud connecting multiple enterprise networks. The cloud network signaling diagram 300 may implement aspects of or be implemented by aspects of wireless communications system 100 described with reference to FIG. 1. The cloud network signaling diagram 300 may include a cloud network controller 305, a network agent 310, and a network function 315 of a private cellular network, which may be examples of the corresponding devices described herein. The cloud network controller 305 may be an example of a cloud-based service that remotely manages aspects of one or more of the private cellular networks. Each private cellular network may include a network agent 310 and one or more of the network functions 315.

Aspects of the architecture described herein may include the network agent 310 receiving or otherwise obtaining a local-based request to initiate a cloud-based procedure associated with network parameter(s). The network parameter(s) may be associated with cloud network credentials that correspond to or are otherwise associated with the private cellular network. The local-based request may include the network agent 310 receiving or otherwise obtaining the local-based request from a network device (such as a network function 315 associated with the network entity or device) that triggers the cloud-based procedure with the cloud network controller 305. Additionally, or alternatively, the local-based request may be internally or autonomously originated by the network agent 310. Accordingly, the network agent 310 may transmit or otherwise output a cloud-based request to initiate the cloud-based procedure according to the local-based request. The cloud-based request may indicate at least a portion of the network parameter(s) while omitting at least a portion of local credential(s) of the private cellular network.

Additionally, or alternatively, the network agent 310 may receive or otherwise obtain (and the cloud network controller 305 may transmit or otherwise output) a cloud-based request for network parameter(s) associated with cloud network credentials that correspond to the private cellular network associated with the network agent 310. The cloud-based request may be received or otherwise obtained from the cloud network controller 305 (such as via the public network, such as the internet). In some aspects, the cloud network credentials exchanged over the public network may include the identifier associated with a network function 315 corresponding to the network entity or device. The network agent 310 may transmit or otherwise output a local-based request according to the cloud-based request and local credential(s) of the network device of the private cellular network that are different from the cloud network credential(s). The local credential(s) may include various parameters, credentials, security information, or other private information associated with the network function 315 or the private cellular network. The network agent 310 may receive or otherwise obtain a local-based response from the network device (such as the network function 315) according to the local-based request that includes the network parameter(s). Accordingly, the network agent 310 may transmit or otherwise output (and the cloud network controller 305 may receive or otherwise obtain) a cloud-based response to the cloud network controller 305 that indicates at least a portion of the network parameter(s) and omits at least a portion of the local credential(s) of the network device of the private cellular network.

The local-based request(s) or response(s) may include local credential(s) or identifiers associated with a mapping of the local credential(s) to an identifier corresponding to the network function 315 associated with the network entity or device of the private cellular network. The local-based request(s) or response(s) may include local credential(s) required for communicating with the network agent. The cloud-based request(s) or response(s) may carry or otherwise include an indication of the identifier. The identifier of the network function 315 or an identifier associated with the network function 315 may be mapped to the network function 315 (or the network device associated with the network function 315) and used for identification of the network function 315 in communications with the cloud network controller 305. The identifier being mapped to the network function 315 may be used in the cloud-based request(s) or response(s) to link the cloud-based procedure to the network function 315. The cloud-based procedure may include any procedure where the network entity or device associated with the identifier is managed (such as initialized, updated, deleted, or otherwise monitored) by the cloud network controller 305 via the network agent 310.

As shown in FIG. 3, the network agent 310 may include a smart bus receiver 320 that is communicatively coupled with a configuration request creator 350 of the cloud network controller 305 (such as via a public network, such as the internet, to exchange cloud-based request(s) or response(s)). The network agent 310 may include a network configuration client 325 that manages aspects of the configuration(s) for each network function 315 associated with the network agent 310. In the example shown in FIG. 3, the network agent 310 is associated with N network functions, which are illustrated as network function 315-a through network function 315-n. The network configuration client 325 may be communicatively coupled with a network operator-to-server 365 of the network function 315 (such as to exchange local-based request(s) or response(s)). The network agent 310 may include a network configuration listener 330 that is also communicatively coupled with the network operator-to-server 365 of the network function 315.

The network agent 310 may include a smart bus sender 335 that is communicatively coupled with a configuration response listener 355 of the cloud network controller 305 (such as via the public network, such as the internet, to exchange cloud-based request(s) or response(s)). The network agent 310 may include a configuration manager 340 that manages aspects of the configuration of the one or more of the network functions 315 that are associated with the network agent 310. The configuration manager 340 may manage aspects of the mapping of the identifier of or associated with each network function 315 to be used for cloud-based procedures with the network function 315. The network agent 310 may include a network function (NF) entry 345 that manages aspects of the local-based request(s) or response(s) communicated between the network agent 310 and the network function 315. The network function entry 345 may manage aspects of a private key (PK) (such as credentialing information), a network function cloud identifier, or other information. The network function entry 345 may be an example of a firewall that separates the network function 315 within the private cellular network and the cloud network controller 305 that communicates with the network agent 310 via the public network. The network function entry 345 may manage aspects of a local network function IP or fully qualified domain name (FQDN) address information as well as secure shell/transport layer security (SSH/TLS) security protocols for each network function 315.

The cloud network signaling diagram 300 illustrates an example of message exchanges between the cloud network controller 305, the network agent 310, and the network function 315 according to the architecture described herein. At (1)), a command (such as a cloud-based request) is sent to the network agent 310 over the public network. The cloud-based request may be output by the configuration request creator 350 of the cloud network controller 305 and provided to the smart bus receiver 320 of the network agent 310. At (2)), the command may be mapped to Netconf and sent to the network function with the local credentials. The smart bus receiver 320 may output the cloud-based request to the network configuration client 325 that manages aspects of the mapping between the identifier and the local credential(s) of the network function 315 (such as network function 315-a in this example). The network configuration client 325 may output a local-based request to the network operator-to-server 365 which may communicate with the system report 360 of the network function 315 to identify or otherwise determine a local-based response.

At (3)), the local-based response may be output from the network function 315 to the network agent 310. The local-based response may carry or otherwise indicated network parameter(s) associated with the cloud credentials (such as associated with the identifier mapping). The local-based response may be output from the network operator-to-server 365 of the network function 315 to the network configuration listener 330 (such as the Netconf) of the network agent 310. At (4) the network agent 310 may map the response to the original request and notify the cloud network controller 305 over the public network. The network agent 310 may transmit or otherwise output the cloud-based response to the cloud network controller 305 via the public network. The cloud-based response may be output from the smart bus sender 335 of the network agent 310 to the configuration response listener 355 of the cloud network controller 305. The cloud-based response may indicate at least some of the network parameters while omitting at least some of the local credentials of the network device of the private cellular network.

In some implementations, the cloud-based request(s) or response(s) may be a secured communications using a message queuing telemetry transport (MQTT) protocol (such as for data) or using an advanced message queuing protocol (AMQP) (such as for control information). In some implementations, cloud-based request(s) or response(s) may secured communications exchanged over the public network according to a shared access signature (SRS) token-based authentication protocol, a trusted platform module (TPM), or an X.509 certificate authentication protocol.

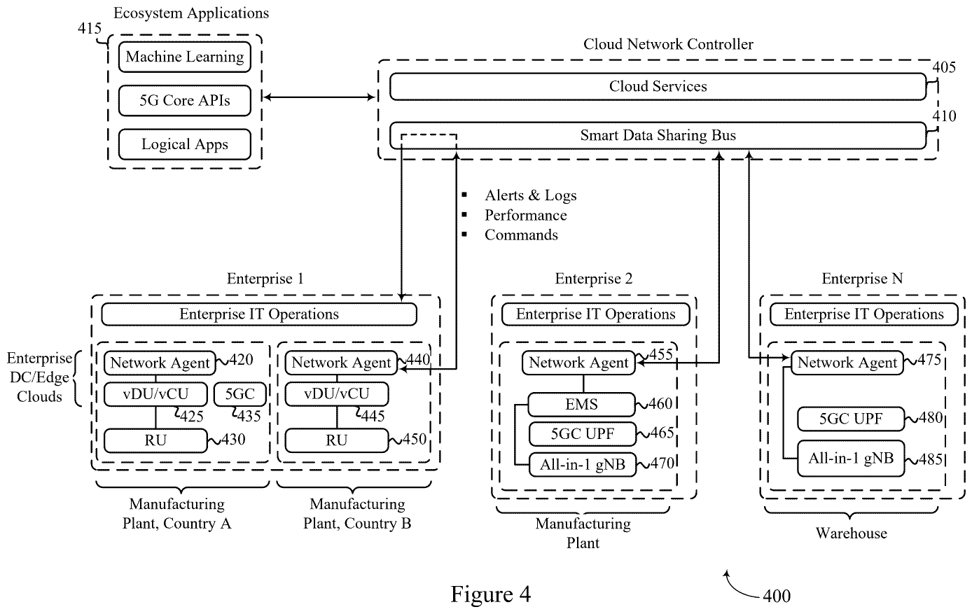

FIG. 4 shows an example of a cloud network signaling diagram 400 that supports centralized management cloud connecting multiple enterprise networks. The cloud network signaling diagram 400 may implement aspects of or be implemented by aspects of wireless communications system 100 described with reference to FIG. 1. The cloud network signaling diagram 400 may include a cloud network controller, a network agent, and a network function of a private cellular network, which may be examples of the corresponding devices described herein. The cloud network controller may be an example of a cloud-based service (such as cloud services 405) that remotely manages aspects of one or more of the private cellular networks via a smart data sharing bus 410. Each private cellular network may include a network agent and one or more of the network functions.

Aspects of the architecture described herein may include the network agent receiving or otherwise obtaining a local-based request to initiate a cloud-based procedure associated with network parameter(s). The network parameter(s) may be associated with cloud network credentials that correspond to or are otherwise associated with the private cellular network. The local-based request may include the network agent receiving or otherwise obtaining the local-based request from a network device (such as a network function associated with the network entity or device) that triggers the cloud-based procedure with the cloud network controller. Additionally, or alternatively, the local-based request may be internally or autonomously originated by the network agent. Accordingly, the network agent may transmit or otherwise output a cloud-based request to initiate the cloud-based procedure according to the local-based request. The cloud-based request may indicate at least a portion of the network parameter(s) while omitting at least a portion of local credential(s) of the private cellular network.

Additionally, or alternatively, the network agent may receive or otherwise obtain (and the cloud network controller may transmit or otherwise output) a cloud-based request for network parameter(s) associated with cloud network credentials that correspond to the private cellular network associated with the network agent. The cloud-based request may be received or otherwise obtained from the cloud network controller (such as via the public network, such as the internet). In some aspects, the cloud network credentials exchanged over the public network may include the identifier associated with a network function corresponding to the network entity or device. The network agent may transmit or otherwise output a local-based request according to the cloud-based request and local credential(s) of the network device of the private cellular network that are different from the cloud network credential(s). The local credential(s) may include various parameters, credentials, security information, or other private information associated with the network function or the private cellular network. The network agent may receive or otherwise obtain a local-based response from the network device (such as the network function) according to the local-based request that includes the network parameter(s). Accordingly, the network agent may transmit or otherwise output (and the cloud network controller may receive or otherwise obtain) a cloud-based response to the cloud network controller that indicates at least a portion of the network parameter(s) and omits at least a portion of the local credential(s) of the network device of the private cellular network.

The local-based request(s) or response(s) may include local credential(s) associated with a mapping of the local credential(s) to an identifier corresponding to the network function associated with the network entity or device of the private cellular network. The cloud-based request(s) or response(s) may carry or otherwise include an indication of the identifier. The identifier of the network function or an identifier associated with the network function may be mapped to the network function (or the network device associated with the network function) and used for identification of the network function in communications with the cloud network controller. The identifier being mapped to the network function may be used in the cloud-based request(s) or response(s) to link the cloud-based procedure to the network function. The cloud-based procedure may include any procedure where the network entity or device associated with the identifier is managed (such as initialized, updated, deleted, or otherwise monitored) by the cloud network controller via the network agent.

As shown in FIG. 4, the cloud network controller may remotely manage various different types of private cellular networks. In some implementations, the cloud network controller may operatively communicate with ecosystem applications 415 that provide various information used to manage aspects of the different types of private cellular networks. The ecosystem applications 415 may provide information related to various machine learning (ML) or artificial intelligence (AI) functions or features, 5G or 6G core network application programming interfaces (APIs), or logical applications that may be used in managing the private cellular networks.

In one example, a first private cellular network may correspond to a first enterprise network (such as enterprise 1). The first private cellular network may include or be associated with enterprise information technology (IT) operations that provides access to the public network (such as access to the smart data sharing bus 410 of the cloud network controller). In this example, the first enterprise includes two private cellular networks, a manufacturing plant located in country A and a manufacturing plant located in country B. The manufacturing plant located in country A may include a network agent 420 that manages aspects of the RAN for the private cellular network. In this example, the RAN includes an enterprise DC to edge cloud split that includes a virtual DU/virtual CU (vDU/vCU) 425 and a 5G core network 435. The RAN includes one or more of the RU 430 that are communicatively coupled with the vDU/vCU 425. The manufacturing plant located in country B may include a network agent 440 and a vDU/vCU 445 in the enterprise DC/edge client plane. The RAN may include the vDU/vCU 445 along with one or more of the RU 450. In some aspects, the network agent 420 or the network agent 440 may communicate with the cloud network controller (such as via the smart data sharing bus 410), such as to exchange various alerts or logs, performance information, commands, or other information.

In another example, a private cellular network may include a second enterprise (enterprise 2) that includes a RAN deployed within a manufacturing plant. The second enterprise also may include enterprise IT operations that provide communications between the network agent 455 and the cloud network controller. The RAN of this private cellular network may include an element management system (EMS) 460 that communicates with the network agent 455 via one or more EMS APIs. The RAN also may include a 5G core UPF 465 and an all-in-one gNB 470 (such as a stand-alone network entity).

In another example, a private cellular network may include a third enterprise (enterprise 3) that includes a RAN deployed within a warehouse. The third enterprise also may include the enterprise IT operations that provide communications between the network agent 475 and the cloud network controller.

The RAN of this private cellular network may include a 5G core UPF 480 and an all-in-one gNB 485 (such as a stand-alone network entity). The network agent 475 may communicate with the all-in-one gNB 485 via a O.1/Netconf configuration or protocol.

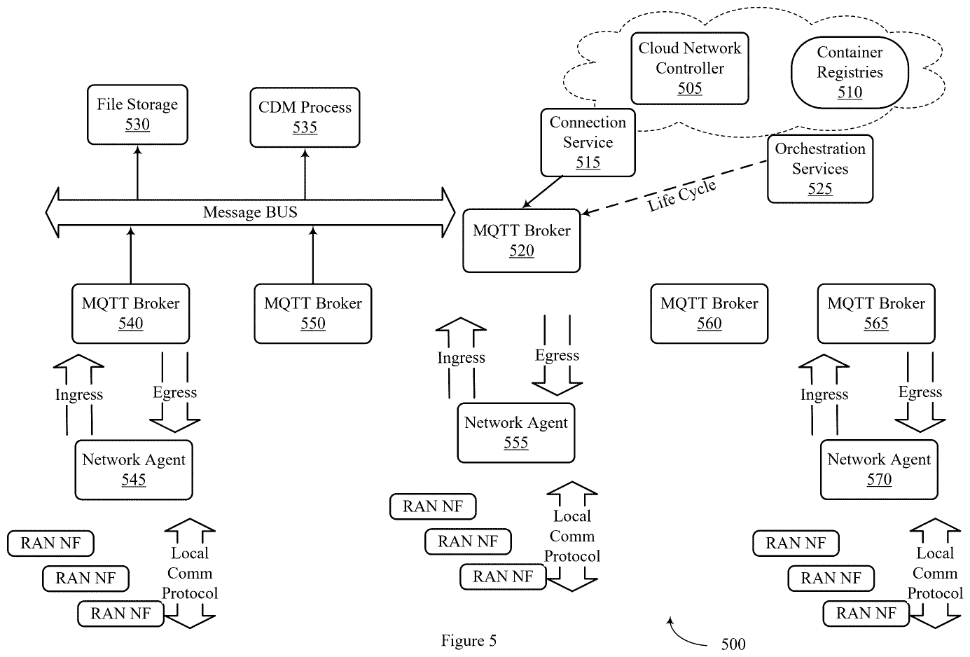

FIG. 5 shows an example of a cloud network architecture 500 that supports centralized management cloud connecting multiple enterprise networks. The cloud network architecture 500 may implement aspects of or be implemented by aspects of wireless communications system 100 described with reference to FIG. 1. The cloud network architecture 500 may include a cloud network controller 505, a network agent, and a network function of a private cellular network (such as a RAN NF), which may be examples of the corresponding devices described herein. The cloud network controller 505 may be an example of a cloud-based service (such as cloud services) that remotely manages aspects of one or more of the private cellular networks via a connection service 515 (such as a smart data sharing bus). Each private cellular network may include a network agent and one or more of the network functions.

Aspects of the architecture described herein may include the network agent receiving or otherwise obtaining a local-based request to initiate a cloud-based procedure associated with network parameter(s). The network parameter(s) may be associated with cloud network credentials that correspond to or are otherwise associated with the private cellular network. The local-based request may include the network agent receiving or otherwise obtaining the local-based request from a network device (such as a network function associated with the network entity or device) that triggers the cloud-based procedure with the cloud network controller 505. Additionally, or alternatively, the local-based request may be internally or autonomously originated by the network agent. Accordingly, the network agent may transmit or otherwise output a cloud-based request to initiate the cloud-based procedure according to the local-based request. The cloud-based request may indicate at least a portion of the network parameter(s) while omitting at least a portion of local credential(s) of the private cellular network.

Additionally, or alternatively, the network agent may receive or otherwise obtain (and the cloud network controller 505 may transmit or otherwise output) a cloud-based request for network parameter(s) associated with cloud network credentials that correspond to the private cellular network associated with the network agent. The cloud-based request may be received or otherwise obtained from the cloud network controller 505 (such as via the public network, such as the internet). In some aspects, the cloud network credentials exchanged over the public network may include the identifier associated with a network function corresponding to the network entity or device. The network agent may transmit or otherwise output a local-based request according to the cloud-based request and local credential(s) of the network device of the private cellular network that are different from the cloud network credential(s). The local credential(s) may include various parameters, credentials, security information, or other private information associated with the network function or the private cellular network. The network agent may receive or otherwise obtain a local-based response from the network device (such as the network function) according to the local-based request that includes the network parameter(s). Accordingly, the network agent may transmit or otherwise output (and the cloud network controller may receive or otherwise obtain) a cloud-based response to the cloud network controller 505 that indicates at least a portion of the network parameter(s) and omits at least a portion of the local credential(s) of the network device of the private cellular network.

The local-based request(s) or response(s) may include local credential(s) associated with a mapping of the local credential(s) to an identifier corresponding to the network function associated with the network entity or device of the private cellular network. The cloud-based request(s) or response(s) may carry or otherwise include an indication of the identifier. The identifier of the network function or an identifier associated with the network function may be mapped to the network function (or the network device associated with the network function) and used for identification of the network function in communications with the cloud network controller 505. The identifier being mapped to the network function may be used in the cloud-based request(s) or response(s) to link the cloud-based procedure to the network function. The cloud-based procedure may include any procedure where the network entity or device associated with the identifier is managed (such as initialized, updated, deleted, or otherwise monitored) by the cloud network controller 505 via the network agent.

The cloud network architecture 500 illustrates an example of effective control for multiple distributed private cellular networks. The network agent associated with each private cellular network may include a software program that is running on the premises at the customer site and part of the local private cellular network. The network agent may support various security features for the private cellular network. The network agent may provide for secure device provisioning and identity management using such mechanism as a shared access signature (SAS) token-based authentication or X.509 certificate authentication to ensure secure communications between the network agents and the cloud service (such as the cloud network controller 505). The network agent may support aspects of various communications protocols for the private cellular network. The network agent may provide for communication patterns supported by the cloud services, such as agent-to-cloud message exchanges, file uploads from network agents, and request-reply methods for cloud-to-agent control commands. The network agents may support scalability and integration within the private cellular network. The cloud services may scale to support millions of network agents and events per second. The cloud services may integrate with other services such as logic apps, machine learning or artificial intelligence functions, and stream analytics for the enterprise IT integration.

The architecture described herein may include the cloud network controller 505, the container registry 510, the connection service 515, the orchestration services 525, and one or more MQTT broker services or functions (such as MQTT broker 540, MQTT broker 550, MQTT broker 520, MQTT broker 560, and MQTT broker 565). The various components shown in FIG. 5 may operatively communicate via a message bus (such as, Kafka message BUS), such as communications between the MQTT brokers and a file storage 530 or a communication distribution manager (CDM) process 535. Each MQTT broker may communicate with one or more network agents associated with a private cellular network. The MQTT broker 540 may communicate with a network agent 545 associated with a private cellular network. The network agent 545 may use various local communication protocols to communicate with one or more network functions of the RAN (RAN NF). The MQTT broker 520 may communicate with a network agent 555, which also may use various local communication protocols to communicate with one or more network functions of the RAN. The MQTT broker 565 may communicate with a network agent 570, which also may use various local communication protocols to communicate with one or more network functions of the RAN.

Accordingly, in this example the cloud services may include a platform of cloud services running on the cloud (such as accessible via the internet). The cloud services may be distributed between different regions, in some implementations. The CDM process 535 may manage aspects of collecting the messages from the MQTT broker and relay the messages to the cloud services for use. The CDM process 535 may manage aspects of collecting cloud-to-network agent messages from the cloud services and pass those messages to the network agents (such as via the MQTT brokers). The file storage 530 may include a cloud file storage that provides a place for files uploaded from the network agents to be shared with the cloud services, or vice versa. The orchestration services 525 may manage aspects of the life cycle of the network agents. The container registry 510 may be a holding container (such as dockers) of the network agent services. Upon network agent deployment the containers may be fetched from this registry. The registry may be responsible for the validity of the software using different security methods. The MQTT brokers may manage aspects of sending messages to or from the network agents. The MQTT brokers may be distributed globally, in some implementations. The network agents may include edge devices that are on the premises of the private cellular network. The RAN NF(s) may include the cellular radio managed by the cloud services. This is an example of the devices deployed in a local private cellular network and managed by the cloud services using the techniques described herein. The connection service 515 may be a cloud service that manages aspects of the connection(s) with the network agents.

In some aspects, an example of a cloud-to-agent communication procedure may include the cloud network controller 505 sending a command to a specific RAN NF. The application may prepare the command and mark it with a unique identifier (such as an identifier of or otherwise associated with the RAN NF). The command may be sent to the CDM process 535 with the details of the specific RAN NF. The CDM process 535 may allocate the network agent responsible for the RAN NF and send the message to the associated MQTT broker with the network agent details. The MQTT broker may route the message to the network agent wrapped inside of an MQTT message. The network agent may receive the message (such as a cloud-based request) via the ingress connection. The network agent may strip the message and allocate the RAN NF connection details in its internal database according to the provided network function identifier. The network function may allocate the network function IP address, associated protocol, port, username, password, and the like (such as local credentials) for the message. The network agent may open a Netconf session to the RAN NF using the connection details (or finds an open session if one already exists) and sends the command to the RAN NF using Netconf (such as in a local-based request). The network agent may receive the answer (such as a local-based response) from the RAN NF and prepare a message back to the cloud services (such as a cloud-based response) that is marked with the unique identifier.

In some aspects, an example of a network agent-to-cloud communications procedure may include the network agent sending the answer from the RAN NF to the cloud services application. The message may be marked with the unique identifier from the cloud-based request. The network agent may send the message to the MQTT broker via the egress connection. The MQTT broker may verify the authenticity of the message and route the message to the CDM process 535 that is responsible for or otherwise associated with the network agent. The MQTT broker may apply various operations according to the MQTT message type (such as may send the message via the message BUS to the associated CDM process 535). The CDM process 535 may receive the message via the message BUS and looks at the internal message type. In this example, the message may be for a specific cloud services application. Accordingly, the CDM process 535 may send the message on the appropriate queue. The cloud services may receive the message and identify the message as the response from the RAN NF for a previously given command according to the unique identifier. In some aspects, there may be preparation steps during the network agent deployment and the RAN NF installation that allows the parties involved (such as the cloud services, MQTT brokers, network agent) to have the metadata used to route, authenticate, and cipher the messages.

In some implementations, other connection models may be applied for the message exchanges. The connection model may use a pub-sub messaging model similar to MQTT but without the full MQTT standards. In some implementations, the connection model may implement end-to-end encryption without a VPN. The TLS version 1.2 may be used to encrypt all data transported between the cloud services and the network agents (such as the cloud-based request(s) or response(s)). The encryption may be associated with Rivest-Shamir-Adleman (RSA)-keyed server certificates on the connection server side and cipher suites on the network agent side. In some implementations, this may support client authentication, such as after a successful TLS handshake the shared access signature or X.509 (by way of example only) certificate may be used by the client to create a signature which is validated by the connection services and provides authenticity to the connection. In some implementations, the handshake may support the use of port 443. That is, the MQTT port and similar standard ports (such as TCP port 8883 for MQTT) may be blocked in some corporate networking environments. To avoid complex deployment actions such as corporate firewall settings, may use communications over web sockets. In some implementations, the communications may support the network agent communicating with the cloud services similar to any corporate browser communicating with the internet. This may support client and cloud keep-alive functionality. In order to ensure a client/cloud connection stays alive, both the connection service and the clients may regularly send a keep-alive ping to each other. In some implementations, the described architecture may support separate ingress and egress communications. The ingress communications (such as cloud services-to-network agents) and the egress communications (such as network agents-to-cloud services) data transport may use different encryption keys and separate authentication actions. This may provide a higher degree of protection from cyber-attacks (such as compared to VPN). In some implementations, the described architecture may support no public IP addresses. The cloud services may send messages to the network agents without knowing the network agent IP address or FQDN and without accessing the network agent directly. This may be associated with the pub-sub messaging model.

This supports various communication protocols and scalability functions. In some implementations, the communication protocols and scalability functions may support cloud control messaging where the cloud services is aware of the network agent status. Using control messages, the cloud services may reboot the network agent, upgrade the software, collect logs, and similar control activities. The messaging may support direct messaging where the network agent can send short messages (for example, such as up to 256 kb, etc.) to the cloud services, and vice versa. Ensuring the messages are short may allow the scalability performance using the MQTT. The network agent may mark up to any number of messages as one message and it will be assembled and delivered as one message, which allows direct messages of up to 1 Mb.

In some implementations, the described architecture may support file uploads where the network agent can upload files to the cloud file server for the cloud services, or vice versa. The files may be broken into smaller pieces to be uploaded MQTT messages and assembled again by the cloud services. The cloud services can access the uploaded file using a shared access signature which is sent by the network agent in a separate message for each file. The file upload feature may support function activation where the cloud services can send a unique message type to the network agent which will activate different applications or functions to support cloud control over the network agent. The file upload feature may support moving logic execution to the network agent, thus supporting very large scalability. In some implementations, the described architecture may be based on distributed MQTT brokers that are globally distributed brokers to allow large scalability and high performance. This is associated with communications between the MQTT brokers to support any-to-any message passing which is achieved using technologies such as MQTT. The architecture may support an internal message bus (such as Kafka bus) where data (such as direct messages or files) from the consumer by the cloud services is shared and not send directly to the network agents.

In some implementations, the described architecture may support translating WAN protocols to LAN protocols. The cloud services may send the commands to the network agent using a WAN protocol (such as HTTP) and the network agent may translate the command using the protocol known to the RAN NF, such as the Netconf protocol which is a LAN protocol. The commands may support the cloud services to perform local RAN NF configuration activities from the cloud services over the WAN protocol (such as using LAN protocol such as Netconf over WAN will endure instability and damage the system scalability).

The use may include the cloud services reading from the network agents. The cloud-based request(s) or response(s) may be secure communications exchanged over the public network. The communications may be secured using shared access signature token-based authentication protocol, or an X.509 certificate authentication protocol. Additionally, the cloud-based request(s) or response(s) may be exchanged in accordance with a message bus protocol (such as such as a MQTT broker protocol or other pub-sub protocol). In this example where the network agent reads from the cloud services, the network parameter(s) indicated in the cloud-based response includes various configuration information, performance metrics, or fault information associated with the private cellular network. The cloud services may communicate with 5G cellular nodes located at the private cellular network around the globe to collect configuration files, performance metrics, and faults from the private cellular network.

The described architecture may include the cloud services writing configuration information to the private cellular network. The cloud services may perform day-one and day-two configuration and optimization of the private cellular network by sending configuration commands to the 5G nodes or to the nodes of the element management system (EMS). The cloud-based request may indicate initial provisioning information for the private cellular network and the local-based request and the local-based response may initially configure the private cellular network for cellular communications.

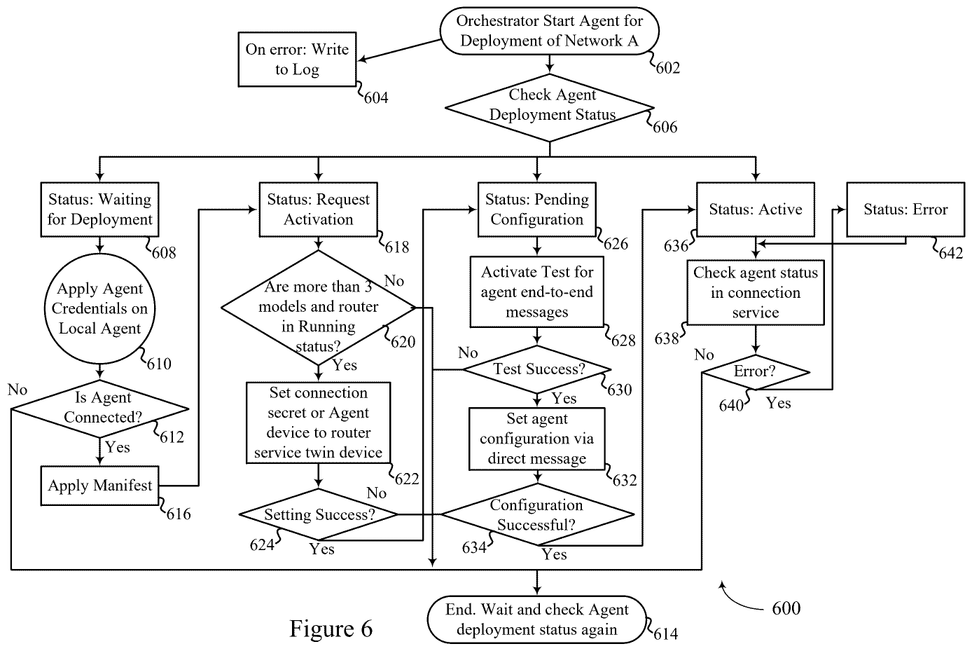

FIG. 6 shows an example of a method 600 that supports centralized management cloud connecting multiple enterprise networks. The method 600 may implement aspects of or be implemented by aspects of wireless communications system 100 described with reference to FIG. 1. Aspects of the method 600 may be implemented at or implemented by a cloud network controller, a network agent, and a network function of a private cellular network, which may be examples of the corresponding devices described herein. The cloud network controller may be an example of a cloud-based service (such as cloud services) that remotely manages aspects of one or more of the private cellular networks via a connection service (such as a smart data sharing bus). Each private cellular network may include a network agent and one or more of the network functions.

Aspects of the architecture described herein may include the network agent receiving or otherwise obtaining a local-based request to initiate a cloud-based procedure associated with network parameter(s). The network parameter(s) may be associated with cloud network credentials that correspond to or are otherwise associated with the private cellular network. The local-based request may include the network agent receiving or otherwise obtaining the local-based request from a network device (such as a network function associated with the network entity or device) that triggers the cloud-based procedure with the cloud network controller. Additionally, or alternatively, the local-based request may be internally or autonomously originated by the network agent. Accordingly, the network agent may transmit or otherwise output a cloud-based request to initiate the cloud-based procedure according to the local-based request. The cloud-based request may indicate at least a portion of the network parameter(s) while omitting at least a portion of local credential(s) of the private cellular network.

Additionally, or alternatively, the network agent may receive or otherwise obtain (and the cloud network controller may transmit or otherwise output) a cloud-based request for network parameter(s) associated with cloud network credentials that correspond to the private cellular network associated with the network agent. The cloud-based request may be received or otherwise obtained from the cloud network controller (such as via the public network, such as the internet). The cloud network credentials exchanged over the public network may include the identifier associated with a network function corresponding to the network entity or device. The network agent may transmit or otherwise output a local-based request according to the cloud-based request and local credential(s) of the network device of the private cellular network that are different from the cloud network credential(s). The local credential(s) may include various parameters, credentials, security information, or other private information associated with the network function or the private cellular network. The network agent may receive or otherwise obtain a local-based response from the network device (such as the network function) according to the local-based request that includes the network parameter(s). Accordingly, the network agent may transmit or otherwise output (and the cloud network controller may receive or otherwise obtain) a cloud-based response to the cloud network controller that indicates at least a portion of the network parameter(s) and omits at least a portion of the local credential(s) of the network device of the private cellular network.

The local-based request(s) or response(s) may include local credential(s) associated with a mapping of the local credential(s) to an identifier corresponding to the network function associated with the network entity or device of the private cellular network. The cloud-based request(s) or response(s) may carry or otherwise include an indication of the identifier. The identifier of the network function or an identifier associated with the network function may be mapped to the network function (or the network device associated with the network function) and used for identification of the network function in communications with the cloud network controller. The identifier being mapped to the network function may be used in the cloud-based request(s) or response(s) to link the cloud-based procedure to the network function. The cloud-based procedure may include any procedure where the network entity or device associated with the identifier is managed (such as initialized, updated, deleted, or otherwise monitored) by the cloud network controller via the network agent.

The method 600 illustrates an example of an effective orchestration of the software models (such as the network agents) on customer isolated premises. Aspects of the method 600 may support device management and lifecycle of the network agents, including the planning, provisioning, configuration, monitoring, and decommissioning of the network agents or the network devices within the private cellular network. The use of device twins to store metadata enables the cloud services to query and management the on-premises network agents efficiently. The method 600 may support an extensibility model that allows the addition of new features and capabilities to the network agents, catering to a diverse set of private cellular networks and user requirements. The architecture described herein use IoT connectivity (such as turning on/off lights from an app on a smart phone) to enable the private RAN connectivity to the cloud services. This supports monitoring and debugging associated with a view of near real-time logs of the on-premises network agent, in the cloud, including push (periodic) and pull (on request) of the logs.

At 602, the orchestrator start agent may be initialized for the deployment of network A (such as a private cellular network). If an error is detected, at 604 the orchestrator start agent may write information relating to the error in a log file. At 606, the method may check the network agent (agent) deployment status. At 608, the method may include determining that the status of the network agent is waiting for deployment. Accordingly, at 610 the method may apply agent credentials on the local agent (such as applying cloud credentials to the network agent). At 612, the method may determine whether the agent is connected (such as associated with application of the agent credentials). If the network agent is not connected, at 614 the method may move to an end state where the orchestrator start agent waits and checks the network agent deployment status again. If the network agent is connected, the orchestrator start agent may move to 616 and apply the manifest for the network agent. At 618 the method may move to where the status of the network agent is requesting activation. At 620, the orchestrator start agent may determine whether there are more than three models and router in a running status. If not, the orchestrator start agent may again move to 614 to the end state. When yes at 620, at 622 the method may set the connection secret or agent device to router service twin device. At 624, the method may determine whether the setting was successful. When no at 624, the method may move to 614 to the end state. If yes at 624, the method may move to 626 where the status of the network agent is pending configuration. At 628 the method may activate the test for the network agent end-to-end messages. At 630, the orchestrator start agent may determine whether the test was successful. If no at 630, the method may again move to 614 to the end state. If yes at 630, at 632 the orchestrator start agent may set the network agent configuration (such as via a direct message). At 634, the method may determine whether the configuration was successful. If no at 634, the method may again move to 614 to the end state. If yes at 634, the method may proceed to 636 where the status of the network agent is active. At 638, the orchestrator start agent may check the network agent status in the connection services. At 640, the method may determine whether there was an error with the network agent status in the connection service. If yes at 640, the method may move to 642 where an error status is determined for the network agent. If no at 640, the method may move to again move to 614 to the end state.

The local-based request and the cloud-base request may be configured to coordinate a procedure for the network agent in accordance with a life cycle management message. The life cycle management message may include an initial installation message or a software upgrade message associated with the network agent. In some implementations the cloud-based request may indicate a network agent life cycle management message to the private cellular network associated with the network agent. The local-based request and the local-based response may be configured to coordinate a procedure for the network agent according to the network agent life cycle management message. The network agent life cycle management message in this example may include an initial installation message, a software upgrade message, a suspension message, or a resume message associated with the network agent. The cloud-based request may indicate a network function life cycle management message associated with a network function associated with the network agent. The local-based request and the local-based response may be configured to coordinate a procedure for the network function according to the network function life cycle management message. The network function life cycle management message may include an initial installation message, a software upgrade message, a suspension message, or a resume message associated with the network function.

The method 600 may support using a mechanism for network agent device management associated with operating a local RAN manager that facilitates the innovative communication. The orchestration service may be a service that is responsible for deploying the software on the remote network agent and to upgrade it when needed. The container registry may be a global storage place that holds the network agent software and allows the network agent to download the software during initial installation and upgrades. The registry may apply different security measures to ensure an allowed party can download software from it. The manifest may be a file that holds all the data on the network agent services, such as the credentials for the container registry, the docker image name per-service, the default configuration of each service, and the storage and communication related information. During the deployment of the network agent, the manifest may be used to by the orchestration service to determine what to deploy. The manifest also allows adding specific services (features) without re-installing the network agent. The docker may be an example of a container being used for the network agent. The network agent services are separated in a way that each service has its own docker file. This provides for installing each service and to upgrade specific services as needed. This also allows using the manifest for orchestration. The twin device is a method to hold information on the cloud and on the network agent at the same time. The orchestrating service may include using the information to configure each service of the network agent, with specific values related only to it, during the initial deployment and upgrades.

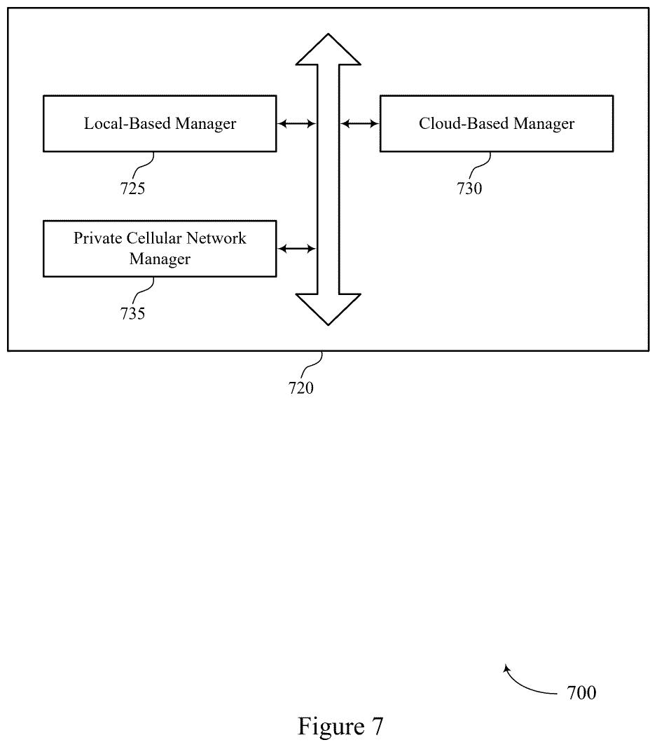

FIG. 7 shows a block diagram 700 of a network entity 720 that supports centralized management cloud connecting multiple enterprise networks. The network entity 720 may be an example of aspects of a network entity, a network agent, a network function, or a cloud network controller, as described with reference to FIGS. 1-6. The network entity 720, or various components thereof, may be an example of means for performing various aspects of centralized management cloud connecting multiple enterprise networks as described herein. The network entity 720 may include a local-based manager 725, a cloud-based manager 730, a private cellular network manager 735, or any combination thereof. Each of these components, or components or subcomponents thereof (such as one or more processors, one or more memories), may communicate, directly or indirectly, with one another (such as via one or more buses). The communications may include communications within a protocol layer of a protocol stack, communications associated with a logical channel of a protocol stack (such as between protocol layers of a protocol stack, within a device, component, or virtualized component associated with a network entity 105, between devices, components, or virtualized components associated with a network entity 105), or any combination thereof.

The network entity 720 may support wireless communications in accordance with examples as disclosed herein. The local-based manager 725 is capable of, configured to, or operable to support a means for obtaining a local-based request to initiate a cloud-based procedure associated with one or more network parameters, where the one or more network parameters are associated with one or more cloud network credentials that correspond to a private cellular network. The cloud-based manager 730 is capable of, configured to, or operable to support a means for outputting a cloud-based request to initiate the cloud-based procedure in accordance with the local-based request, where the cloud-based request indicates at least a portion of the one or more network parameters and omits at least a portion of one or more local credentials of the private cellular network. In some implementations, the network agent obtains the local-based request from a network device of the private cellular network associated with the network agent. In some implementations, the local-based request includes an internally originated request of the network agent.

In some implementations, the cloud-based request includes an identifier corresponding to a network function associated with a network device of the private cellular network, and the local-based request includes one or more local credentials in accordance with a mapping of the one or more local credentials to the identifier corresponding to the network function. In some implementations, the one or more network parameters indicated in the cloud-based request include a cell configuration associated with the private cellular network. In some implementations, the one or more local credentials omitted from the cloud-based request include cell credentials and connectivity information associated with the private cellular network. In some implementations, the one or more network parameters indicated in the cloud-based request include a cell node update associated with the private cellular network. In some implementations, the cloud-based request includes secured communications exchanged over a public network.

In some implementations, the secured communications exchanged over the public network are in accordance with a shared access signature token-based authentication protocol, a TPM, or an X.509 certificate authentication protocol. In some implementations, the cloud-based request between a cloud network controller and the network agent are exchanged in accordance with a message bus protocol. In some implementations, the one or more network parameters indicated in the cloud-based request include configuration information, performance metrics, and fault information associated with the private cellular network. In some implementations, the local-based request and the cloud-based request are configured to coordinate a procedure for the network agent in accordance with a life cycle management message. In some implementations, the life cycle management message includes at least one of an initial installation message or a software upgrade message associated with the network agent.

Additionally, or alternatively, the network entity 720 may support wireless communications in accordance with examples as disclosed herein. In some implementations, the cloud-based manager 730 is capable of, configured to, or operable to support a means for obtaining, from a cloud network controller, a cloud-based request for one or more network parameters associated with one or more cloud network credentials that correspond to a private cellular network associated with the network agent. In some implementations, the local-based manager 725 is capable of, configured to, or operable to support a means for outputting a local-based request in accordance with the cloud-based request and one or more local credentials of a network device of the private cellular network that are different from the one or more cloud network credentials. In some implementations, the local-based manager 725 is capable of, configured to, or operable to support a means for obtaining, from the network device of the private cellular network, a local-based response to the local-based request that includes the one or more network parameters. In some implementations, the cloud-based manager 730 is capable of, configured to, or operable to support a means for outputting a cloud-based response indicating at least a portion of the one or more network parameters, where the cloud-based response omits at least a portion of the one or more local credentials of the network device of the private cellular network.

In some implementations, the cloud-based request includes an identifier corresponding to a network function associated with the network device of the private cellular network, and the local-based request and the local-based response include one or more local credentials in accordance with a mapping of the one or more local credentials to the identifier corresponding to the network function. In some implementations, the cloud-based request indicates a request for a cell configuration of the private cellular network and the one or more network parameters indicated in the cloud-based response include the cell configuration. In some implementations, the one or more local credentials omitted from the cloud-based response include cell credentials and connectivity information associated with the private cellular network. In some implementations, the cloud-based request indicates a cell configuration for the private cellular network, and the local-based request forwards the indicated cell configuration to the network device of the private cellular network.

In some implementations, the cloud-based request includes a request for a cell node update associated with the private cellular network, and the one or more network parameters indicated in the cloud-based response confirm the cell node update. In some implementations, the cloud-based request and the cloud-based response include secured communications exchanged over a public network.

In some implementations, the secured communications exchanged over the public network are in accordance with a shared access signature token-based authentication protocol, a TPM, or an X.509 certificate authentication protocol. In some implementations, the cloud-based request and the cloud-based response between the cloud network controller and the network agent are exchanged in accordance with a message bus protocol. In some implementations, the one or more network parameters indicated in the cloud-based response include configuration information, performance metrics, and fault information associated with the private cellular network. In some implementations, the cloud-based request indicates initial provisioning information for the private cellular network, and the local-based request and local-based response initially configure the private cellular network for cellular communications.

In some implementations, the cloud-based request indicates a network agent life cycle management message to the private cellular network associated with the network agent, and the local-based request and the local-based response are configured to coordinate a procedure for the network agent in accordance with the network agent life cycle management message. In some implementations, the network agent life cycle management message includes at least one of an initial installation message, a software upgrade message, a suspension message, a resume message, or any combination thereof, associated with the network agent. In some implementations, the cloud-based request indicates a network function life cycle management message associated with a network function of the private cellular network, and the local-based request and the local-based response are configured to coordinate to coordinate a procedure for the network function in accordance with the network function life cycle management message. In some implementations, the network function life cycle management message includes at least one of an initial installation message, a software upgrade message, a suspension message, a resume message, or any combination thereof, associated with the network function.

Additionally, or alternatively, the network entity 720 may support wireless communications in accordance with examples as disclosed herein. The private cellular network manager 735 is capable of, configured to, or operable to support a means for outputting a cloud-based request requesting one or more network parameters associated with one or more cloud network credentials that correspond to a private cellular network. In some implementations, the private cellular network manager 735 is capable of, configured to, or operable to support a means for obtaining, from a network agent associated with the private cellular network, a cloud-based response indicating at least a portion of the one or more network parameters, where the cloud-based response omits at least a portion of one or more local credentials of the private cellular network.

In some implementations, the cloud-based request indicates an identifier corresponding to a network function associated with a network device of the private cellular network. In some implementations, the one or more local credentials omitted from the cloud-based response include cell credentials and connectivity information associated with the private cellular network. In some implementations, the cloud-based request and the cloud-based response include secured communications exchanged over a public network. In some implementations, the secured communications exchanged over the public network are in accordance with a shared access signature token-based authentication protocol, a TPM, or an X.509 certificate authentication protocol.

In some implementations, the cloud-based request and the cloud-based response between the cloud network controller and the network agent are exchanged in accordance with a message bus protocol. In some implementations, the cloud-based request indicates a network agent life cycle management message to the private cellular network associated with the network agent. In some implementations, the cloud-based request indicates a network function life cycle management message associated with a network function of the private cellular network.

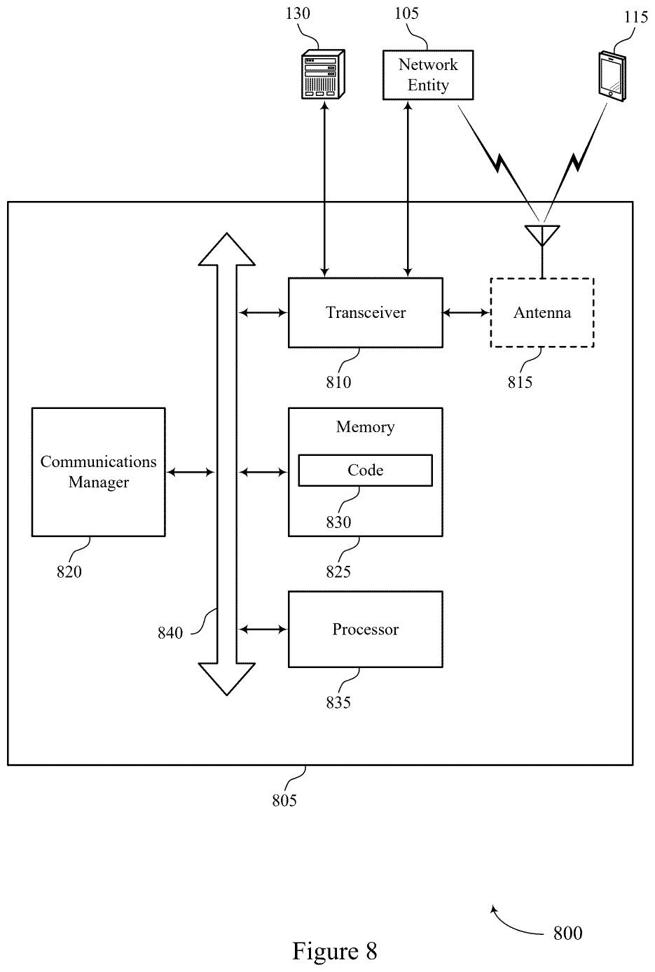

FIG. 8 shows a diagram of a system 800 including a device 805 that supports centralized management cloud connecting multiple enterprise networks. The device 805 may communicate with one or more network entities (such as one or more components of one or more BSs 105), one or more UEs 115, one or more network agents, one or more network functions, one or more core network controllers, or any combination thereof, which may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (such as operatively, communicatively, functionally, electronically, electrically) via one or more buses (such as a bus 840). The communications manager 820, the transceiver 810, the one or more antennas 815, the at least one memory 825, the code 830, and the at least one processor 835, alone or in any combination, may implement aspects of or be implemented by aspects of the one or more UEs 115, the one or more network agents, the one or more network functions, the one or more core network controllers, or any combination thereof.

The transceiver 810 may support bi-directional communications via wired links, wireless links, or both as described herein. In some implementations, the transceiver 810 may include a wired transceiver and may communicate bi-directionally with another wired transceiver. Additionally, or alternatively, in some implementations, the transceiver 810 may include a wireless transceiver and may communicate bi-directionally with another wireless transceiver. In some implementations, the device 805 may include one or more antennas 815, which may be capable of transmitting or receiving wireless transmissions (such as concurrently). The transceiver 810 also may include a modem to modulate signals, to provide the modulated signals for transmission (such as by one or more antennas 815, by a wired transmitter), to receive modulated signals (such as from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations associated with received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (such as the at least one processor 835, the at least one memory 825, or both), may be included in a chip or chip assembly that is installed in the device 805. In some implementations, the transceiver 810 may be operable to support communications via one or more communications links (such as communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some implementations, the code 830 may not be directly executable by a processor of the at least one processor 835 but may cause a computer (such as when compiled and executed) to perform functions described herein. In some implementations, the at least one memory 825 may include, among other things, a BIOS which may control basic hardware or software operation such as the interaction with peripheral components or devices. In some implementations, the at least one processor 835 may include multiple processors and the at least one memory 825 may include multiple memories. One or more of the multiple processors may be coupled with one or more of the multiple memories which may, individually or collectively, be configured to perform various functions herein (such as, as part of a processing system).

The at least one processor 835 may include one or more intelligent hardware devices (such as one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some implementations, the at least one processor 835 may be configured to operate a memory array using a memory controller. In some other implementations, a memory controller may be integrated into one or more of the at least one processor 835. The at least one processor 835 may be configured to execute computer-readable instructions stored in a memory (such as one or more of the at least one memory 825) to cause the device 805 to perform various functions (such as functions or tasks supporting centralized management cloud connecting multiple enterprise networks). The device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (such as one or more physical nodes and supporting software such as operating systems, virtual machines, or container instances) that may host the functions (such as by executing code 830) to perform the functions of the device 805. The at least one processor 835 may be any one or more suitable processors capable of executing scripts or instructions of one or more software programs stored in the device 805 (such as within one or more of the at least one memory 825).

In some implementations, the at least one processor 835 may include multiple processors and the at least one memory 825 may include multiple memories. One or more of the multiple processors may be coupled with one or more of the multiple memories, which may, individually or collectively, be configured to perform various functions herein. In some implementations, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. The at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some implementations, a bus 840 may support communications of (such as within) a protocol layer of a protocol stack. In some implementations, a bus 840 may support communications associated with a logical channel of a protocol stack (such as between protocol layers of a protocol stack), which may include communications performed within a component of the device 805, or between different components of the device 805 that may be co-located or located in different locations (such as where the device 805 may refer to a system in which one or more of the communications manager 820, the transceiver 810, the at least one memory 825, the code 830, and the at least one processor 835 may be located in one of the different components or divided between different components).

In some implementations, the communications manager 820 may manage aspects of communications with a core network 130 (such as via one or more wired or wireless backhaul links). The communications manager 820 may manage the transfer of data communications for client devices, such as one or more UEs 115. In some implementations, the communications manager 820 may manage communications with one or more other network entities 105 and may include a controller or scheduler for controlling communications with UEs 115 (such as in cooperation with the one or more other network devices). In some implementations, the communications manager 820 may support an X2 interface within an LTE/LTE-A wireless communications network technology to provide communication between network entities 105.

The communications manager 820 may support wireless communications. The communications manager 820 is capable of, configured to, or operable to support a means for obtaining a local-based request to initiate a cloud-based procedure associated with one or more network parameters, where the one or more network parameters are associated with one or more cloud network credentials that correspond to a private cellular network. The communications manager 820 is capable of, configured to, or operable to support a means for outputting a cloud-based request to initiate the cloud-based procedure in accordance with the local-based request, where the cloud-based request indicates at least a portion of the one or more network parameters and omits at least a portion of one or more local credentials of the private cellular network.

Additionally, or alternatively, the communications manager 820 may support wireless communications. The communications manager 820 is capable of, configured to, or operable to support a means for obtaining, from a cloud network controller, a cloud-based request for one or more network parameters associated with one or more cloud network credentials that correspond to a private cellular network associated with the network agent. The communications manager 820 is capable of, configured to, or operable to support a means for outputting a local-based request in accordance with the cloud-based request and one or more local credentials of a network device of the private cellular network that are different from the one or more cloud network credentials. The communications manager 820 is capable of, configured to, or operable to support a means for obtaining, from the network device of the private cellular network, a local-based response to the local-based request that includes the one or more network parameters. The communications manager 820 is capable of, configured to, or operable to support a means for outputting a cloud-based response indicating at least a portion of the one or more network parameters, where the cloud-based response omits at least a portion of the one or more local credentials of the network device of the private cellular network.

Additionally, or alternatively, the communications manager 820 may support wireless communications. The communications manager 820 is capable of, configured to, or operable to support a means for outputting a cloud-based request requesting one or more network parameters associated with one or more cloud network credentials that correspond to a private cellular network. The communications manager 820 is capable of, configured to, or operable to support a means for obtaining, from a network agent associated with the private cellular network, a cloud-based response indicating at least a portion of the one or more network parameters, where the cloud-based response omits at least a portion of one or more local credentials of the private cellular network.

In some implementations, the communications manager 820 may be configured to perform various operations (such as receiving, obtaining, monitoring, outputting, transmitting) using or otherwise in cooperation with the transceiver 810, the one or more antennas 815 (such as where applicable), or any combination thereof. Although the communications manager 820 is illustrated as a separate component, in some implementations, one or more functions described with reference to the communications manager 820 may be supported by or performed by the transceiver 810, one or more of the at least one processor 835, one or more of the at least one memory 825, the code 830, or any combination thereof (such as, by a processing system including at least a portion of the at least one processor 835, the at least one memory 825, the code 830, or any combination thereof). The code 830 may include instructions executable by one or more of the at least one processor 835 to cause the device 805 to perform various aspects of centralized management cloud connecting multiple enterprise networks as described herein, or the at least one processor 835 and the at least one memory 825 may be otherwise configured to, individually or collectively, perform or support such operations.

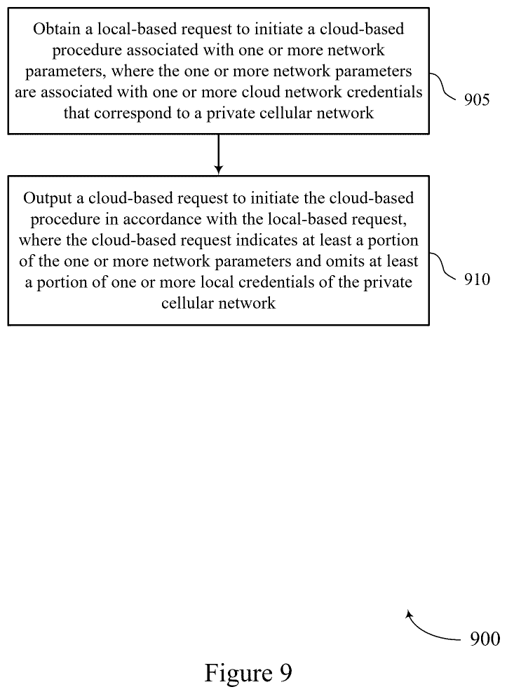

FIG. 9 shows a flowchart illustrating a method 900 that supports centralized management cloud connecting multiple enterprise networks. The operations of the method 900 may be implemented by a network entity (such as a network agent) or its components as described herein. The operations of the method 900 may be performed by a network entity as described with reference to FIGS. 1-8. In some implementations, a network entity may execute a set of instructions to control the functional elements of the network entity to perform the described functions. Additionally, or alternatively, the network entity may perform aspects of the described functions using special-purpose hardware.

At 905, the method may include obtaining a local-based request to initiate a cloud-based procedure associated with one or more network parameters, where the one or more network parameters are associated with one or more cloud network credentials that correspond to a private cellular network. The operations of 905 may be performed in accordance with examples as disclosed herein. In some implementations, aspects of the operations of 905 may be performed by a local-based manager 725 as described with reference to FIG. 7.

At 910, the method may include outputting a cloud-based request to initiate the cloud-based procedure in accordance with the local-based request, where the cloud-based request indicates at least a portion of the one or more network parameters and omits at least a portion of one or more local credentials of the private cellular network. The operations of 910 may be performed in accordance with examples as disclosed herein. In some implementations, aspects of the operations of 910 may be performed by a cloud-based manager 730 as described with reference to FIG. 7.

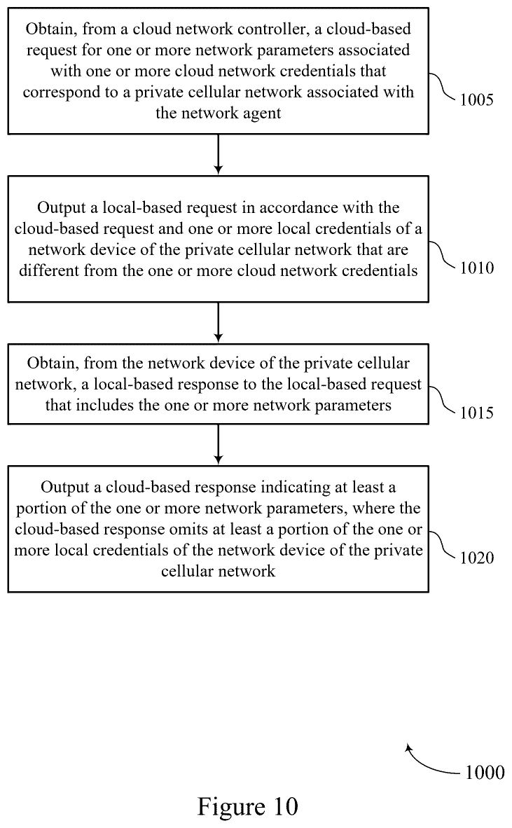

FIG. 10 shows a flowchart illustrating a method 1000 that supports centralized management cloud connecting multiple enterprise networks. The operations of the method 1000 may be implemented by a network entity (such as a network agent) or its components as described herein. The operations of the method 1000 may be performed by a network entity as described with reference to FIGS. 1-8. In some implementations, a network entity may execute a set of instructions to control the functional elements of the network entity to perform the described functions. Additionally, or alternatively, the network entity may perform aspects of the described functions using special-purpose hardware.

At 1005, the method may include obtaining, from a cloud network controller, a cloud-based request for one or more network parameters associated with one or more cloud network credentials that correspond to a private cellular network associated with the network agent. The operations of 1005 may be performed in accordance with examples as disclosed herein. In some implementations, aspects of the operations of 1005 may be performed by a cloud-based manager 730 as described with reference to FIG. 7.

At 1010, the method may include outputting a local-based request in accordance with the cloud-based request and one or more local credentials of a network device of the private cellular network that are different from the one or more cloud network credentials. The operations of 1010 may be performed in accordance with examples as disclosed herein. In some implementations, aspects of the operations of 1010 may be performed by a local-based manager 725 as described with reference to FIG. 7.

At 1015, the method may include obtaining, from the network device of the private cellular network, a local-based response to the local-based request that includes the one or more network parameters. The operations of 1015 may be performed in accordance with examples as disclosed herein. In some implementations, aspects of the operations of 1015 may be performed by a local-based manager 725 as described with reference to FIG. 7.

At 1020, the method may include outputting a cloud-based response indicating at least a portion of the one or more network parameters, where the cloud-based response omits at least a portion of the one or more local credentials of the network device of the private cellular network. The operations of 1020 may be performed in accordance with examples as disclosed herein. In some implementations, aspects of the operations of 1020 may be performed by a cloud-based manager 730 as described with reference to FIG. 7.

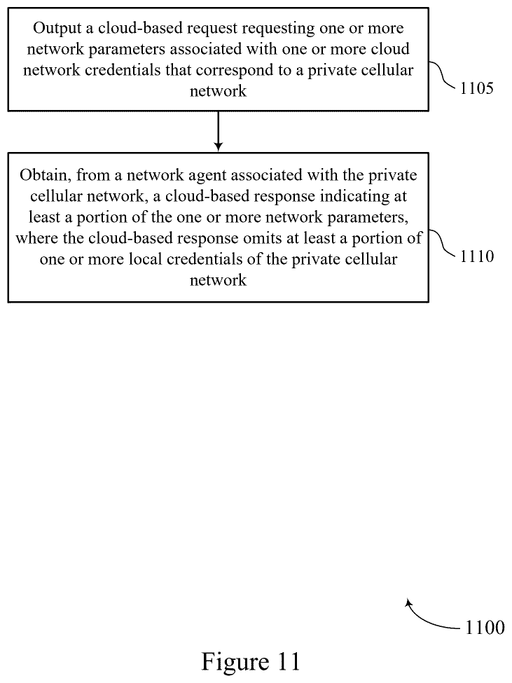

FIG. 11 shows a flowchart illustrating a method 1100 that supports centralized management cloud connecting multiple enterprise networks. The operations of the method 1100 may be implemented by a network entity (such as a cloud network controller) or its components as described herein. The operations of the method 1100 may be performed by a network entity as described with reference to FIGS. 1-8. In some implementations, a network entity may execute a set of instructions to control the functional elements of the network entity to perform the described functions. Additionally, or alternatively, the network entity may perform aspects of the described functions using special-purpose hardware.

At 1105, the method may include outputting a cloud-based request requesting one or more network parameters associated with one or more cloud network credentials that correspond to a private cellular network. The operations of 1105 may be performed in accordance with examples as disclosed herein. In some implementations, aspects of the operations of 1105 may be performed by a private cellular network manager 735 as described with reference to FIG. 7.

At 1110, the method may include obtaining, from a network agent associated with the private cellular network, a cloud-based response indicating at least a portion of the one or more network parameters, where the cloud-based response omits at least a portion of one or more local credentials of the private cellular network. The operations of 1110 may be performed in accordance with examples as disclosed herein. In some implementations, aspects of the operations of 1110 may be performed by a private cellular network manager 735 as described with reference to FIG. 7.

The following provides an overview of some aspects of the present disclosure:

The following provides an overview of aspects of the present disclosure:
Aspect 1: A method for wireless communications at a network agent, including: obtaining a local-based request to initiate a cloud-based procedure associated with one or more network parameters, where the one or more network parameters are associated with one or more cloud network credentials that correspond to a private cellular network; and outputting a cloud-based request to initiate the cloud-based procedure in accordance with the local-based request, where the cloud-based request indicates at least a portion of the one or more network parameters and omits at least a portion of one or more local credentials of the private cellular network.
Aspect 2: The method of aspect 1, where the network agent obtains the local-based request from a network device of the private cellular network associated with the network agent.
Aspect 3: The method of any of aspects 1 through 2, where the local-based request includes an internally originated request of the network agent.
Aspect 4: The method of any of aspects 1 through 3, where the cloud-based request includes an identifier corresponding to a network function associated with a network device of the private cellular network, and the local-based request includes one or more local credentials in accordance with a mapping of the one or more local credentials to the identifier corresponding to the network function.
Aspect 5: The method of any of aspects 1 through 4, where the one or more network parameters indicated in the cloud-based request include a cell configuration associated with the private cellular network.
Aspect 6: The method of any of aspects 1 through 5, where the one or more local credentials omitted from the cloud-based request include cell credentials and connectivity information associated with the private cellular network.
Aspect 7: The method of any of aspects 1 through 6, where the one or more network parameters indicated in the cloud-based request include a cell node update associated with the private cellular network.
Aspect 8: The method of any of aspects 1 through 7, where the cloud-based request includes secured communications exchanged over a public network.
Aspect 9: The method of aspect 8, where the secured communications exchanged over the public network are in accordance with a shared access signature token-based authentication protocol, a TPM, or an X.509 certificate authentication protocol.
Aspect 10: The method of any of aspects 1 through 9, where the cloud-based request between a cloud network controller and the network agent are exchanged in accordance with a message bus protocol.
Aspect 11: The method of any of aspects 1 through 10, where the one or more network parameters indicated in the cloud-based request include configuration information, performance metrics, and fault information associated with the private cellular network.
Aspect 12: The method of any of aspects 1 through 11, where the local-based request and the cloud-based request are configured to coordinate a procedure for the network agent in accordance with a life cycle management message.
Aspect 13: The method of aspect 12, where the life cycle management message includes at least one of an initial installation message or a software upgrade message associated with the network agent.
Aspect 14: A method for wireless communications at a network agent, including: obtaining, from a cloud network controller, a cloud-based request for one or more network parameters associated with one or more cloud network credentials that correspond to a private cellular network associated with the network agent; outputting a local-based request in accordance with the cloud-based request and one or more local credentials of a network device of the private cellular network that are different from the one or more cloud network credentials; obtaining, from the network device of the private cellular network, a local-based response to the local-based request that includes the one or more network parameters; and outputting a cloud-based response indicating at least a portion of the one or more network parameters, where the cloud-based response omits at least a portion of the one or more local credentials of the network device of the private cellular network.
Aspect 15: The method of aspect 14, where the cloud-based request includes an identifier corresponding to a network function associated with the network device of the private cellular network, and the local-based request and the local-based response include one or more local credentials in accordance with a mapping of the one or more local credentials to the identifier corresponding to the network function.
Aspect 16: The method of any of aspects 14 through 15, where the cloud-based request indicates a request for a cell configuration of the private cellular network and the one or more network parameters indicated in the cloud-based response include the cell configuration.
Aspect 17: The method of any of aspects 14 through 16, where the one or more local credentials omitted from the cloud-based response include cell credentials and connectivity information associated with the private cellular network.
Aspect 18: The method of any of aspects 14 through 17, where the cloud-based request indicates a cell configuration for the private cellular network, and the local-based request forwards the indicated cell configuration to the network device of the private cellular network.
Aspect 19: The method of any of aspects 14 through 18, where the cloud-based request includes a request for a cell node update associated with the private cellular network, and the one or more network parameters indicated in the cloud-based response confirm the cell node update.
Aspect 20: The method of any of aspects 14 through 19, where the cloud-based request and the cloud-based response include secured communications exchanged over a public network.
Aspect 21: The method of aspect 20, where the secured communications exchanged over the public network are in accordance with a shared access signature token-based authentication protocol, a TPM, or an X.509 certificate authentication protocol.
Aspect 22: The method of any of aspects 14 through 21, where the cloud-based request and the cloud-based response between the cloud network controller and the network agent are exchanged in accordance with a message bus protocol.
Aspect 23: The method of any of aspects 14 through 22, where the one or more network parameters indicated in the cloud-based response include configuration information, performance metrics, and fault information associated with the private cellular network.
Aspect 24: The method of any of aspects 14 through 23, where the cloud-based request indicates initial provisioning information for the private cellular network, and the local-based request and local-based response initially configure the private cellular network for cellular communications.
Aspect 25: The method of any of aspects 14 through 24, where the cloud-based request indicates a network agent life cycle management message to the private cellular network associated with the network agent, and the local-based request and the local-based response are configured to coordinate a procedure for the network agent in accordance with the network agent life cycle management message.
Aspect 26: The method of aspect 25, where the network agent life cycle management message includes at least one of an initial installation message, a software upgrade message, a suspension message, a resume message, or any combination thereof, associated with the network agent.
Aspect 27: The method of any of aspects 14 through 26, where the cloud-based request indicates a network function life cycle management message associated with a network function of the private cellular network, and the local-based request and the local-based response are configured to coordinate to coordinate a procedure for the network function in accordance with the network function life cycle management message.
Aspect 28: The method of aspect 27, where the network function life cycle management message includes at least one of an initial installation message, a software upgrade message, a suspension message, a resume message, or any combination thereof, associated with the network function.
Aspect 29: A method for wireless communications at a cloud network controller, including: outputting a cloud-based request requesting one or more network parameters associated with one or more cloud network credentials that correspond to a private cellular network; and obtaining, from a network agent associated with the private cellular network, a cloud-based response indicating at least a portion of the one or more network parameters, where the cloud-based response omits at least a portion of one or more local credentials of the private cellular network.
Aspect 30: The method of aspect 29, where the cloud-based request indicates an identifier corresponding to a network function associated with a network device of the private cellular network.
Aspect 31: The method of any of aspects 29 through 30, where the one or more local credentials omitted from the cloud-based response include cell credentials and connectivity information associated with the private cellular network.
Aspect 32: The method of any of aspects 29 through 31, where the cloud-based request and the cloud-based response include secured communications exchanged over a public network.
Aspect 33: The method of aspect 32, where the secured communications exchanged over the public network are in accordance with a shared access signature token-based authentication protocol, a TPM, or an X.509 certificate authentication protocol.
Aspect 34: The method of any of aspects 29 through 33, where the cloud-based request and the cloud-based response between the cloud network controller and the network agent are exchanged in accordance with a message bus protocol.
Aspect 35: The method of any of aspects 29 through 34, where the cloud-based request indicates a network agent life cycle management message to the private cellular network associated with the network agent.
Aspect 36: The method of any of aspects 29 through 35, where the cloud-based request indicates a network function life cycle management message associated with a network function of the private cellular network.
Aspect 37: A network agent, including a processing system that includes processor circuitry and memory circuitry that stores code, the processing system configured to cause the first wireless device to perform a method of any of aspects 1-13.
Aspect 38: A network agent, including at least one means for performing a method of any of aspects 1-13.
Aspect 39: A non-transitory computer-readable medium storing code for wireless communications, the code including instructions executable by a processor to perform a method of any of aspects 1-13.
Aspect 40: A network agent, including a processing system that includes processor circuitry and memory circuitry that stores code, the processing system configured to cause the first wireless device to perform a method of any of aspects 14-28.
Aspect 41: A network agent, including at least one means for performing a method of any of aspects 14-28.
Aspect 42: A non-transitory computer-readable medium storing code for wireless communications, the code including instructions executable by a processor to perform a method of any of aspects 14-28.
Aspect 43: A cloud network controller, including a processing system that includes processor circuitry and memory circuitry that stores code, the processing system configured to cause the first wireless device to perform a method of any of aspects 29-36.
Aspect 44: A cloud network controller, including at least one means for performing a method of any of aspects 29-36.
Aspect 45: A non-transitory computer-readable medium storing code for wireless communications, the code including instructions executable by a processor to perform a method of any of aspects 29-36.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and the like. Also, “determining” can include receiving (such as receiving information), accessing (such as accessing data stored in memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. If a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. A component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. Referring to “the one or more components” subsequently in the claims may be understood to be equivalent to referring to “at least one of the one or more components.”

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented using hardware or software depends upon the particular application and design constraints imposed on the overall system.

The hardware and data processing apparatus used to implement the various illustrative logics, logical blocks, modules and circuits described in connection with the aspects disclosed herein may be implemented or performed using a general purpose single-or multi-chip processor, a digital signal processor (DSP), an application specific integrated circuit (ASIC), a graphics processing unit (GPU), a neural processing unit (NPU), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented using hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted using one or more instructions or code of a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one location to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc. Disks may reproduce data magnetically and discs may reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the features disclosed herein.

Additionally, a person having ordinary skill in the art will readily appreciate, the terms “upper” and “lower” are sometimes used for ease of describing the figures and indicate relative positions corresponding to the orientation of the figure on a properly oriented page and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable sub combination. Moreover, although features may be described above as acting in some combinations and even initially claimed as such, one or more features from a claimed combination can be excised from the combination, and the claimed combination may be directed to a sub combination or variation of a sub combination.

Similarly, while operations are depicted in the drawings in a particular order, this may not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. One or more additional operations can be performed before, after, simultaneously, or between any of the illustrated operations. In some circumstances, multitasking and parallel processing may be advantageous. Moreover, the separation of various system components in the implementations described above may not be understood as requiring such separation in all implementations, and it may be understood that the described program components and systems can be integrated together in a single software product or packaged into multiple software products. Additionally, other implementations are within the scope of the following claims. In some implementations, the actions recited in the claims can be performed in a different order and still achieve desirable results.

1. A network agent, comprising:
a processing system that includes processor circuitry and memory circuitry that stores code, the processing system configured to cause the network agent to:
obtain a local-based request to initiate a cloud-based procedure associated with one or more network parameters, wherein the one or more network parameters are associated with one or more cloud network credentials that correspond to a private cellular network; and
output a cloud-based request to initiate the cloud-based procedure in accordance with the local-based request, wherein the cloud-based request indicates at least a portion of the one or more network parameters and omits at least a portion of one or more local credentials of the private cellular network.

2. The network agent of claim 1, wherein the network agent obtains the local-based request from a network device of the private cellular network associated with the network agent.

3. The network agent of claim 1, wherein the local-based request comprises an internally originated request of the network agent.

4. The network agent of claim 1, wherein the cloud-based request includes an identifier corresponding to a network function associated with a network device of the private cellular network, and the local-based request includes one or more local credentials in accordance with a mapping of the one or more local credentials to the identifier corresponding to the network function.

5. The network agent of claim 1, wherein the one or more network parameters indicated in the cloud-based request include a cell configuration associated with the private cellular network.

6. The network agent of claim 1, wherein the one or more local credentials omitted from the cloud-based request include cell credentials and connectivity information associated with the private cellular network.

7. The network agent of claim 1, wherein the one or more network parameters indicated in the cloud-based request include a cell node update associated with the private cellular network.

8. The network agent of claim 1, wherein the cloud-based request comprises secured communications exchanged over a public network.

9. The network agent of claim 8, wherein the secured communications exchanged over the public network are in accordance with a shared access signature (SAS) token-based authentication protocol, a trusted platform module (TPM), or an X.509 certificate authentication protocol.

10. The network agent of claim 1, wherein the cloud-based request between a cloud network controller and the network agent are exchanged in accordance with a message bus protocol.

11. The network agent of claim 1, wherein the one or more network parameters indicated in the cloud-based request include configuration information, performance metrics, and fault information associated with the private cellular network.

12. The network agent of claim 1, wherein the local-based request and the cloud-based request are configured to coordinate a procedure for the network agent in accordance with a life cycle management message.

13. The network agent of claim 12, wherein the life cycle management message includes at least one of an initial installation message or a software upgrade message associated with the network agent.

14. A network agent, comprising:
a processing system that includes processor circuitry and memory circuitry that stores code, the processing system configured to cause the network agent to:
obtain, from a cloud network controller, a cloud-based request for one or more network parameters associated with one or more cloud network credentials that correspond to a private cellular network associated with the network agent;
output a local-based request in accordance with the cloud-based request and one or more local credentials of a network device of the private cellular network that are different from the one or more cloud network credentials;
obtain, from the network device of the private cellular network, a local-based response to the local-based request that includes the one or more network parameters; and
output a cloud-based response indicating at least a portion of the one or more network parameters, wherein the cloud-based response omits at least a portion of the one or more local credentials of the network device of the private cellular network.

15. The network agent of claim 14, wherein the cloud-based request includes an identifier corresponding to a network function associated with the network device of the private cellular network, and the local-based request and the local-based response include one or more local credentials in accordance with a mapping of the one or more local credentials to the identifier corresponding to the network function.

16. The network agent of claim 14, wherein the cloud-based request indicates a request for a cell configuration of the private cellular network and the one or more network parameters indicated in the cloud-based response include the cell configuration.

17. The network agent of claim 14, wherein the one or more local credentials omitted from the cloud-based response include cell credentials and connectivity information associated with the private cellular network.

18.-28. (canceled)

29. A cloud network controller, comprising:
a processing system that includes processor circuitry and memory circuitry that stores code, the processing system configured to cause the cloud network controller to:
output a cloud-based request requesting one or more network parameters associated with one or more cloud network credentials that correspond to a private cellular network; and
obtain, from a network agent associated with the private cellular network, a cloud-based response indicating at least a portion of the one or more network parameters, wherein the cloud-based response omits at least a portion of one or more local credentials of the private cellular network.

30. The cloud network controller of claim 29, wherein the cloud-based request indicates an identifier corresponding to a network function associated with a network device of the private cellular network.

31. The cloud network controller of claim 29, wherein the one or more local credentials omitted from the cloud-based response include cell credentials and connectivity information associated with the private cellular network.

32.-72. (canceled)
